(19) United States
(12) Patent Application Publication
(10) Pub. No.: US 2025/0035825 A1
(43) Pub. Date: Jan. 30, 2025

(54) WEARABLE ELECTRONIC DEVICE INCLUDING TUNABLE LENS

(71) Applicant: Samsung Electronics Co., Ltd., Suwon-si (KR)

(72) Inventors: Chanhyung YOO, Suwon-si (KR); Byungkwon KANG, Suwon-si (KR); Hyunsoo KIM, Suwon-si (KR); Hongsuk KIM, Suwon-si (KR); Soonsang PARK, Suwon-si (KR); Kwangtai KIM, Suwon-si (KR); Dongchoon HWANG, Suwon-si (KR)

(73) Assignee: Samsung Electronics Co., Ltd., Suwon-si (KR)

(21) Appl. No.: 18/781,209

(22) Filed: Jul. 23, 2024

Related U.S. Application Data
(63) Continuation of application No. PCT/KR2024/010648, filed on Jul. 23, 2024.

(30) Foreign Application Priority Data
Jul. 24, 2023 (KR) 10-2023-0095931
Aug. 17, 2023 (KR) 10-2023-0107843

(51) Int. Cl. G02B 3/14; G02B 27/00; G02B 27/01; G02B 27/09

(52) U.S. Cl. CPC G02B 3/14; G02B 27/0093; G02B 27/0172; G02B 27/0955; G02B 2027/0138

(57) ABSTRACT

According to an embodiment, a wearable electronic device may include a camera, a display, a lens assembly configured to focus or guide light beams representing visual information output from the display, the lens assembly including a first lens configured to adjust a refractive index by receiving an electrical signal, at least one processor and memory storing instructions. According to an embodiment, the instructions, when executed by the at least one processor, may cause the wearable electronic device to control the display to output the light beams representing the visual information through the lens assembly. According to an embodiment, the instructions, when executed by the at least one processor, may cause the wearable electronic device to adjust a refractive index of a first area of the first lens corresponding to a first distance from an edge of the first lens to reduce blur of a first object displayed based on the first light beams passing through the first area of the first lens corresponding to the first distance from the edge of the first lens. According to an embodiment, the instructions, when executed by the at least one processor, may cause the wearable electronic device to adjust the refractive index of the second area of the first lens to a second value corresponding to a second distance, which is longer than the first distance, from the edge of the first lens. Various other embodiments may be possible.

### CROSS-REFERENCE TO RELATED APPLICATION(S)

This application is a continuation application, claiming priority under § 365 (c), of an International application No. PCT/KR2024/010648, filed on Jul. 23, 2024, which is based on and claims the benefit of a Korean patent application number 10-2023-0095931, filed on Jul. 24, 2023, in the Korean Intellectual Property Office, and of a Korean patent application number 10-2023-0107843, filed on Aug. 17, 2023, in the Korean Intellectual Property Office, the disclosure of each of which is incorporated by reference herein in its entirety.

### TECHNICAL FIELD

The disclosure relates to an electronic device. More particularly, the disclosure relates to a wearable electronic device including a tunable lens.

### BACKGROUND ART

A portable electronic device (e.g., an electronic scheduler, a portable multimedia reproducer, a mobile communication terminal, or a tablet personal computer (PC)) is generally equipped with a display member (e.g., a display module) and a battery, and has a bar-type, folder-type, or sliding-type appearance due to the shape of the display member or the battery. Recently, as display members and batteries have been improved in performance and downsized, electronic devices that can be worn on a portion of a user's body, such as the wrist or head, or in the form of clothing (hereinafter, referred to as “wearable electronic devices”) are emerging.

Examples of wearable electronic devices include a head-mounted device (HMD), smart glasses, a smart watch (or band), a contact lens-type device, a ring-type device, a clothing/shoe/glove-type device, and the like. These body-worn electronic devices can be easily carried and improved in user accessibility.

As an example, the head mounted display (HMD) is a device that is worn on a user's head or face and allows the user to view a virtual image in a three-dimensional space by projecting an image onto the user's retina. For example, the HMD may be classified into a see-through-type HMD configured to provide augmented reality (AR) or a see-closed-type HMD configured to provide virtual reality (VR). The see-through-type HMD may be implemented, for example, in the form of glasses, and may provide information about buildings, objects, and the like in the user's field of view to the user in the form of an image or text. The see-closed-type HMD may output independent images to both eyes of a user and output content (a game, a movie, streaming, broadcasting, or the like) provided from a mobile communication terminal or external input to the user wearing the HMD, thereby providing an excellent sense of immersion. In addition, the HMD may be used to provide mixed reality (MR) or extended reality (XR), which are a mixture of augmented reality (AR) and virtual reality (VR).

Recently, product development related to the HMD is actively progressing, and the HMD is used for various purposes such as military, gaming, industrial, and medical purposes. Accordingly, there is a demand for a smaller and lighter size while providing good image quality.

The above information is presented as background information only to assist with understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide a wearable electronic device including a tunable lens.

Additional aspects will be set forth in part in the description which follows and, in part, will be apparent from the description, or may be learned by practice of the presented embodiments.

According to an embodiment, a wearable electronic device may include a camera, a display, a lens assembly configured to focus or guide light beams representing visual information output from the display, the lens assembly including a first lens configured to adjust a refractive index by receiving an electrical signal, at least one processor and memory storing instructions. According to an embodiment, the instructions, when executed by the at least one processor, may cause the wearable electronic device to control the display to output the light beams representing the visual information through the lens assembly. According to an embodiment, the instructions, when executed by the at least one processor, may cause the wearable electronic device to adjust a refractive index of a first area of the first lens corresponding to a first distance from an edge of the first lens to reduce blur of a first object displayed based on the first light beams passing through the first area of the first lens corresponding to the first distance from the edge of the first lens. According to an embodiment, the instructions, when executed by the at least one processor, may cause the wearable electronic device to adjust the refractive index of the second area of the first lens to a second value corresponding to a second distance, which is longer than the first distance, from the edge of the first lens.

According to an embodiment, in a method of operating a wearable electronic device, the wearable electronic device may include a camera, a display, a lens assembly configured to focus or guide light beams representing visual information output from the display, the lens assembly including a first lens configured to adjust a refractive index by receiving an electrical signal, and a processor. According to an embodiment, the method of operating the wearable electronic device may include an operation of controlling the display to output the light beams representing the visual information through the lens assembly. According to an embodiment, the method of operating the wearable electronic device may include an operation of adjusting a refractive index of a first area of the first lens corresponding to a first distance from an edge of the first lens to reduce blur of a first object displayed based on the first light beams passing through the first area of the first lens corresponding to the first distance from the edge of the first lens. According to an embodiment, the method of operating the wearable electronic device may include an operation of adjusting the refractive index of the second area of the first lens to a second value corresponding to a second distance, which is longer than the first distance, from the edge of the first lens.

A computer-readable recording medium according to an embodiment may store instructions that, when executed, cause an electronic device to perform the above-described method or operations of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above-described aspects or other aspects, configurations, and/or advantages regarding an embodiment of the disclosure may become more apparent through the following detailed description made with reference to the accompanying drawings.

FIG. 1 is a block diagram illustrating an electronic device within a network environment according to an embodiment of the disclosure;

FIG. 2 is a view illustrating a wearable electronic device according to an embodiment of the disclosure;

FIGS. 3 and 4 are views illustrating the front and rear surfaces of a wearable electronic device according to an embodiment of the disclosure;

FIG. 5 is view exemplifying a path through which light beams output by a display are focused or guided to a user's eyes in a wearable electronic device according to an embodiment of the disclosure;

FIG. 6 is a view illustrating a tunable lens of a wearable electronic device according to an embodiment of the disclosure;

FIG. 7 is a cross-sectional view illustrating the tunable lens of a wearable electronic device, taken along line A-A′ in FIG. 6 according to an embodiment of the disclosure;

FIG. 8 is a cross-sectional view of the tunable lens of a wearable electronic device, taken along line A-A′ in FIG. 6, exemplifying a first operating state of the tunable lens according to an embodiment of the disclosure;

FIG. 9 is a cross-sectional view of the tunable lens of a wearable electronic device, taken along line A-A′ in FIG. 6, exemplifying a second operating state of the tunable lens according to an embodiment of the disclosure;

FIG. 10 is a view illustrating the tunable lens of a wearable electronic device according to an embodiment of the disclosure;

FIG. 11 is a diagram exemplifying an operating state of a tunable lens of a wearable electronic device according to an embodiment of the disclosure;

FIG. 12 is a schematic block diagram of a wearable electronic device according to an embodiment of the disclosure;

FIG. 13 is a flowchart illustrating an operation in which a wearable electronic device adjusts the refractive index of a tunable lens (or a first lens) based on a user's gaze according to an embodiment of the disclosure;

FIGS. 14A and 14B are views illustrating a method of adjusting a refractive index of a tunable lens (or a first lens) by a wearable electronic device according to an embodiment of the disclosure;

FIG. 15 is a flowchart illustrating an operation of adjusting the refractive index of a tunable lens (or a first lens) by a wearable electronic device according to an embodiment of the disclosure;

FIG. 16 is a view illustrating a method of adjusting the refractive index of a tunable lens (or a first lens) by a wearable electronic device according to an embodiment of the disclosure.

FIG. 17 is a flowchart illustrating an operation of dynamically adjusting the refractive index of a tunable lens (or a first lens) by a wearable electronic device based on an angle corresponding to a user's gaze according to an embodiment of the disclosure;

FIG. 18 is a flowchart illustrating an operation of adjusting the refractive indices of a plurality of tunable lenses (or a first lens and a second lens) by a wearable electronic device according to an embodiment of the disclosure;

FIG. 19 is a view illustrating an operation of adjusting the refractive indices of a plurality of tunable lenses (or a first lens and a second lens) by a wearable electronic device according to an embodiment of the disclosure;

FIG. 20 is a view illustrating an operation of adjusting the refractive indices of a plurality of tunable lenses (or a first lens and a second lens) by a wearable electronic device according to an embodiment of the disclosure;

FIG. 21A is a view illustrating an operation of adjusting the refractive index of a tunable lens (or first lens) by a wearable electronic device when the user's gaze is directed toward the front of the lens assembly according to an embodiment of the disclosure;

FIG. 21B is a view illustrating an operation of adjusting the refractive index of a tunable lens (or first lens) by a wearable electronic device when the user's gaze is directed toward a periphery of the lens assembly according to an embodiment of the disclosure; and

FIG. 22 is a view illustrating diagrams each showing a change in modulation transfer function (MTF) value depending on a change in resolution of a peripheral field of a tunable lens according to an embodiment of the disclosure.

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wearable electronic devices implementing augmented reality, virtual reality, mixed reality and/or extended reality may generally be used while worn on a user's head or face. For example, a display configured to output visual information may be placed fairly close to a user's eyes. Depending on a user's eyesight, body type, and/or wearing condition, there may be differences in display performance (e.g., image quality) experienced by the user. By guiding or focusing visual information output from the display to the user's eyes with an optical system (e.g., a lens assembly) capable of adjusting a refractive power or focal length, performance differences actually felt by the user can be suppressed. However, in a wearable electronic device weight-reduced in order to provide a comfortable fit or reduce user fatigue, there may be difficulties in implementing an optical system that can satisfy users with different eyesights, body types, and/or wearing tendencies.

Furthermore, when implementing an optical system by combining a plurality of lenses, the resolution in the peripheral area may be lower than that in the central area. This is due to field curvature (or aberration) depending on the wavelength of incident light and the material and shapes of the lenses, in which as the number of lenses increases, it may be easier to suppress field curvature or aberration. However, in a downsized or lightweight wearable electronic device, it may be difficult to arrange a large number of lenses to sufficiently suppress distortion or aberration.

An embodiment of the disclosure is intended to solve at least the above-described problems and/or disadvantages and provide at least the advantages described later, and is able to provide a wearable device including a tunable lens that facilitates adjustment of optical performance such as adjustment of a refractive power or focal length.

The technical problems to be addressed by the disclosure are not limited to those described above, and other technical problems, which are not described above, may be clearly understood from the following description by a person ordinarily skilled in the related art, to which the disclosure belongs.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

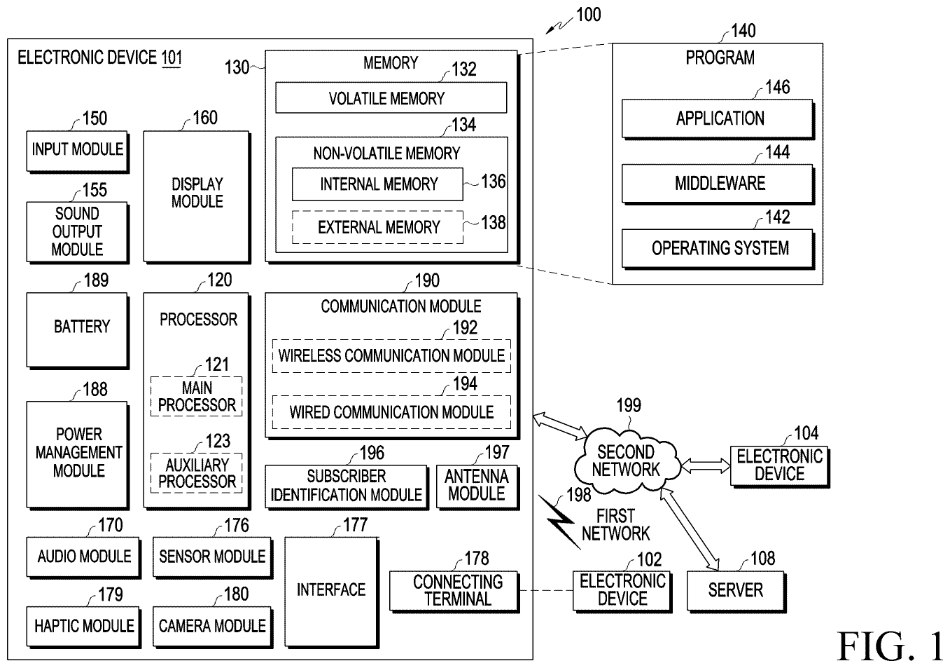

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a fifth generation (5G) network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

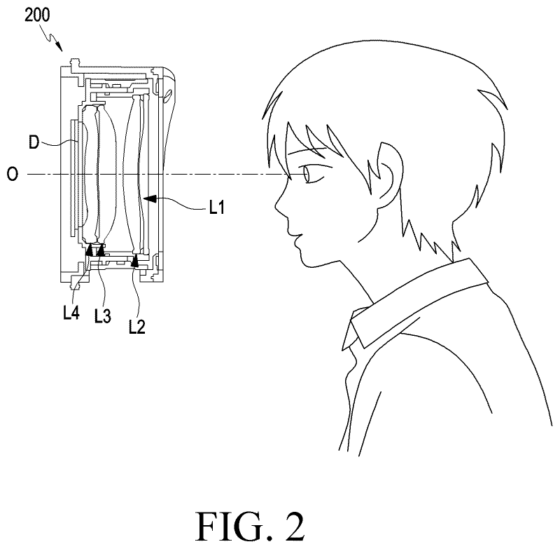

FIG. 2 is a view illustrating a wearable electronic device 200 according to an embodiment of the disclosure.

In describing an embodiment of the disclosure, some numerical values may be presented, but it is to be noted that these values do not limit the embodiment of the disclosure unless described in the claims.

Referring to FIG. 2, a wearable electronic device 200 (e.g., the electronic device 101 in FIG. 1) is an electronic device that can be worn on a user's head or face, and the user is also able to visually recognize surrounding objects or environments even while wearing the wearable electronic device 200. The wearable electronic device 200 may use a camera module to acquire and/or recognize a visual image of an object or environment that the user is looking at or that is located in the direction the wearable electronic device 200 is oriented, and may receive information about the object or environment from an external electronic device via a network. The wearable electronic device 200 may provide the user with the received information about the object or environment in an acoustic or visual form. For example, the wearable electronic device 200 may provide the received information about the object or environment to the user in a visual form by using a display member such as a display module. By implementing information about the object or environments in a visual form and combining the visual form with an actual image (or video) of the user's surrounding environment, the wearable electronic device 200 may implement augmented reality (AR), virtual reality (VR), mixed reality (MR), and/or extended reality (XR). The display member may provide the user with information about an object or environment around the user by outputting a screen in which an augmented reality object is added to the actual image (or video) of the user's surrounding environment.

According to an embodiment, all or some of the operations executed in the electronic device 101 or the wearable electronic device 200 may be executed in one or more of external electronic devices 102, 104, and 108. For example, when the electronic device 101 or the wearable electronic device 200 is to perform certain functions or services automatically or in response to a request from a user or other device, the electronic device 101 or the wearable electronic device 200 may request that one or more external electronic devices 102, 104, and 108 perform at least some of the functions or the services, in place of or in addition to executing the functions or the services by itself. At least one external electronic device, which has received the above-mentioned request, may execute at least some of the requested functions or services, or additional functions or services associated with the request, and may deliver the result of the execution to the electronic device 101 or the wearable electronic device 200. The electronic device 101 or the wearable electronic device 200 may process the result as it is or additionally so as to provide the result at least a part of the response to the request. For example, the external electronic device 102 renders content data executed in an application and then transmits the content data to the electronic device 101 or the wearable electronic device 200, and the electronic device 101 or the wearable electronic device 200 that receives the data may output the content data to a display module. When the electronic device 101 or the wearable electronic device 200 detects the user's motion through a sensor(s) such as an inertial measurement unit sensor, the processor (e.g., the processor 120 in FIG. 1) of the electronic device 101 or the wearable electronic device 200 may correct, based on information on the motion, the rendered data received from the external electronic device 102 and may output the corrected data to the display module. Alternatively, when the user's motion is detected through the sensor(s), the processor of the electronic device 101 or the wearable electronic device 200 (e.g., the processor 120 in FIG. 1) may deliver the motion information to the external electronic device 102 and may request rendering such that screen data is undated according to the motion information. According to various embodiments, the external electronic device 102 may be of various types, such as a case device that is capable of storing and charging the electronic device 101.

In the following detailed description, “a state or location in which an electronic device or a predetermined component of the electronic device faces a user's face” may be variously described, and it is to be noted that the descriptions are made assuming that the user is wearing the wearable electronic device 200.

According to an embodiment, the wearable electronic device 200 may include at least one display member (e.g., the display module 160 in FIG. 1) and a wearing member. Depending on the structure of the display member, the wearable electronic device 200 may further include a structure for mounting or supporting the display member (e.g., a lens frame). A pair of display members including a first display member and a second display member may be provided, in which the first display member and the second display member may be disposed to correspond to the user's right eye and left eye, respectively, in the state in which the wearable electronic device 200 is worn on the user's body. In an embodiment, the wearable electronic device 200 may include a housing shape including one display member corresponding to the right eye and the left eye (e.g., a goggle shape).

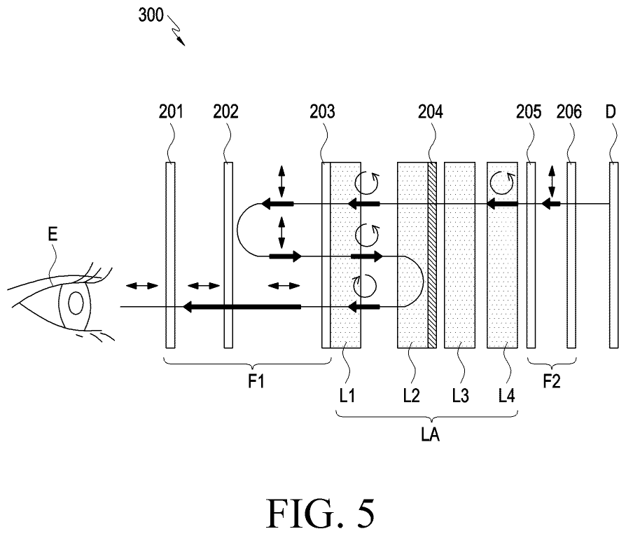

According to an embodiment, the display member is a component equipped to provide visual information to the user and may include, for example, a display D, a plurality of lenses L1, L2, L3, and L4) (e.g., the lens assembly (LA) in FIG. 5) and/or at least one sensor. Here, each of the lens assembly and the display D may be formed to be transparent or translucent. However, the display member is not limited to this. In an embodiment, the display member may include a window member, in which the window member may be translucent glass or a member having light transmittance that is adjustable as the coloring concentration thereof is adjusted. In an embodiment, the display member may include a lens including a waveguide or a reflective lens, and an image output from a light output device (e.g., a projector or display D) may be formed on each lens, thereby allowing visual information to be provided to the user. For example, the display member may mean a display that may include a waveguide (e.g., a light waveguide) in at least a portion of each of the lenses and is capable of transmit an image (or light beams) output from the light output device to the user's eyes through the waveguide included therein and at the same time, capable of transmitting an image of the real world to the user's eyes through the area in a see-through manner. In an embodiment, the waveguide may be understood as a part of a lens assembly. The lens assembly as an optical system includes a plurality of lenses (e.g., L1, L2, L3, and L4) and may be arranged in a space within the wearable electronic device 200 in the state of being aligned with an optical axis O. The configuration in which visual information output from a display D is provided to a user's eyes through a lens assembly will be discussed again below with reference to FIG. 5.

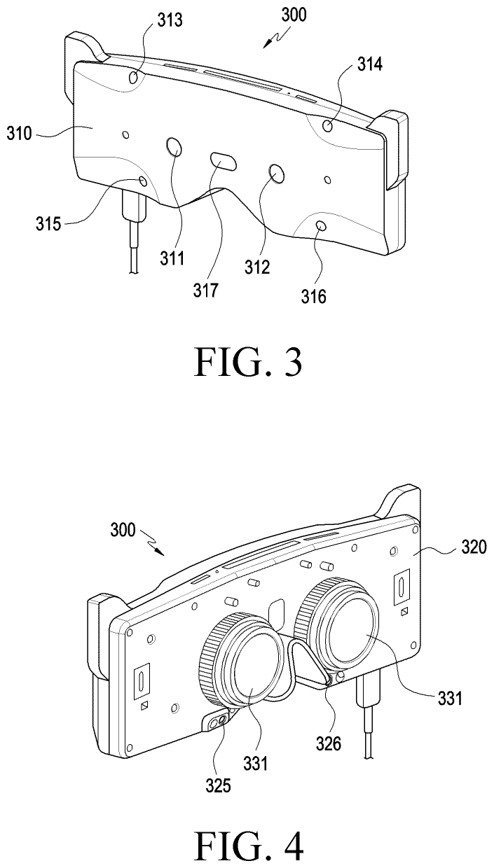

FIGS. 3 and 4 are views illustrating the front and rear surfaces of a wearable electronic device 300 according to an embodiment.

Referring to FIGS. 3 and 4, in an embodiment, camera modules 311, 312, 313, 314, 315, and 316 and/or a depth sensor 317 configured to acquire information related to the surrounding environment of the wearable electronic device 300 may be arranged on a first surface 310 of the electronic device (e.g., a housing) 300.

In an embodiment, the camera modules 311 and 312 may acquire images related to the surrounding environment of the wearable electronic device 300.

In an embodiment, the camera modules 313, 314, 315, and 316 may acquire images while the wearable electronic device is worn by the user. The camera modules 313, 314, 315, and 316 may be used for hand detection and tracking, or user gesture (e.g., hand motion) recognition. The camera modules 313, 314, 315, and 316 may be used for 3-degree-of-freedom (3DoF) or 6DoF head tracking, location (space, environment) recognition, and/or movement recognition. In an embodiment, the camera modules 311 and 312 may be used for hand detection and tracking, or user gesture recognition or detection.

In an embodiment, the depth sensor 317 may be configured to transmit a signal and receive a signal reflected from a subject, and may be used to identify the distance to the object, such as time of flight (TOF). Instead of or in addition to the depth sensor 317, the camera modules 313, 314, 315, and 316 may identify the distance to an object.

According to an embodiment, the camera modules 325 and 326 and/or the display 331 (and/or lenses) for face recognition may be disposed on the second surface 320 of the housing.

In an embodiment, the face recognition camera modules 325 and 326 located adjacent to the display may be used to recognize the user's face, or may recognize and/or track both of the user's eyes.

In an embodiment, the display 331 (and/or lenses) may be disposed on the second surface 320 of the wearable electronic device 300. In an embodiment, the display 331 (and/or lenses) may be at least partially similar to or substantially the same as the display D (and/or lenses L1, L2, L3, and L4) of FIG. 2. In an embodiment, the wearable electronic device 300 may not include camera modules 315 and 316 among the plurality of camera modules 313, 314, 315, and 316. Although not illustrated in FIGS. 3 and 4, the wearable electronic device 300 may further include at least one of the components illustrated in FIGS. 1 and/or FIG. 2.

In an embodiment, the display 331 may be understood as including a display module (e.g., the display module 160 in FIG. 1 or the display D in FIG. 2) configured to output a screen and a lens assembly (e.g., the lens assembly (LA) in of FIG. 5) configured to focus the output screen to a user's eyes. In FIG. 4, it is to be noted that, in the structure of the displays 331, reference numbers are assigned to portions visible from the exterior of the wearable electronic device 300 and are indicated to the lenses closest to the user's eyes.

As described above, the wearable electronic device 300 according to an embodiment may have a form factor to be worn on a user's head. The wearable electronic device 300 may further include a strap and/or a wearing member to be fixed on a portion of a user's body. The wearable electronic device 300 may provide a user experience based on augmented reality, virtual reality, and/or mixed reality while worn on the user's head.

FIG. 5 exemplifies a path through which light beams output by a display D is focused or guided to a user's eyes E in the wearable electronic device 300 according to an embodiment of the disclosure.

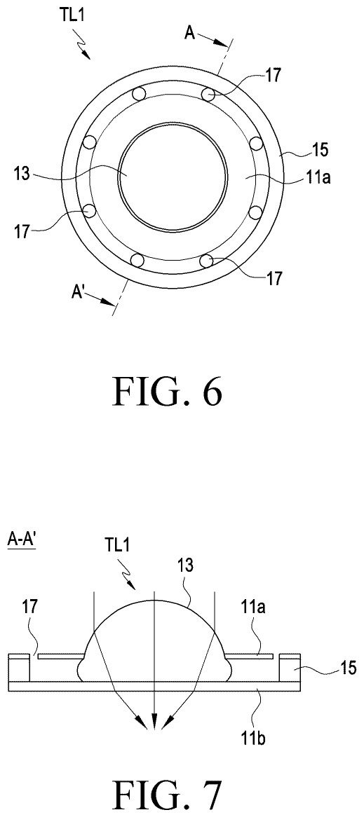

Referring further to FIG. 5 along with FIG. 2, the wearable electronic device 300 according to an embodiment of the disclosure may include a display D, a lens assembly (LA) (e.g., the plurality of lenses L1, L2, L3, and L4), one or more quarter-wave plates QWPs 203 and 205, at least one reflective polarizer (RP) 202, and/or at least one beam splitter 204. In an embodiment, the one or more quarter-wave plates 203 and 205, at least one reflective polarizer 202, and/or at least one beam splitter 204 are to be understood as a part of the lens assembly LA. In an embodiment, at least one of the plurality of lenses L1, L2, L3, and L4 is movable and may provide a vision correction function to a user by adjusting a diopter. In an embodiment, at least one of the plurality of lenses L1, L2, L3, and L4 is implemented as a tunable lens, so that the refractive power or focal length of the lens assembly (LA) can be adjusted. For example, in the lens assembly LA, at least one of the plurality of lenses L1, L2, L3, and L4 may be implemented as a tunable lens to provide an eyesight correction function to the user. This tunable lens will be discussed again with reference to FIGS. 6 to 11. In describing the embodiment(s) of the disclosure, “adjusting a refractive power” includes converting a refractive power into positive or negative one, adjusting a focus, and/or adjusting a focal distance. In an embodiment, in describing the embodiment(s) of the disclosure, “adjusting a refractive power” includes modulating the phase of a light beam passing through the lens assembly (LA) and/or the tunable lens.

According to an embodiment, when moving at least one of the plurality of lenses L1, L2, L3, and L4 for diopter adjustment, an actuator or guide structure configured to move the lens(s) may be provided. In an embodiment, when at least one of the plurality of lenses L1, L2, L3, and L4 is implemented as a tunable lens, a mechanical structure (e.g., an actuator or a guide structure) for diopter adjustment may be omitted. For example, when the lens assembly (LA) includes at least one tunable lens, it may be easy to provide optical performance suitable for a user's eyesight, body type, and/or wearing habit.

According to an embodiment, the one or more one quarter-wave plates 203 and 205, the at least one reflective polarizer 202, and the at least one beam splitter 204 may extend and/or adjust a light propagation path length between the user's eye E and the display D. For example, by implementing a focal length longer than the mechanical or physical length of the lens assembly (LA), it is possible to improve the quality of images provided to the user. Because a wearable electronic device (e.g., AR/VR glasses) is limited in size and weight due to the actual usage environment (e.g., use in the worn state), the resolution of an output virtual image may be limited, and it may be difficult to provide a good quality image to the user even through an optical system. According to an embodiment, the wearable electronic device 300, which includes an optical system (e.g., the lens assembly (LA)) with a pancake lens structure, may increase the optical path length of an incident light beam relative to the external size, and/or improve the resolution of an image provided to the user. For example, the wearable electronic device 300, which includes the display D and the lens assembly LA, may serve as an optical device (e.g., AR/VR glasses) that provides visual information while worn on the user's head or face.

According to an embodiment, the display D may include a screen display area, which exposes visual information to a portion corresponding to both of the user's eyes when the user wears the wearable electronic device 300. In an embodiment, the wearable electronic device 300 may include a pair of displays D corresponding to both of the user's eyes. The display device D may include, for example, a liquid crystal display (LCD), a light-emitting diode (LED) display, an organic light-Emitting diode (OLED) display, a microelectromechanical system (MEMS) display, or an electronic paper display. For example, the display D may display various contents (e.g., text, image, video, icon, symbol, or the like) provided as visual information to a user.

According to an embodiment, various contents (e.g., text, image, video, icon, or symbol, or the like) output in the form of light beams from the display D may pass through the one or more quarter-wave plates 203 and 205, the at least one reflective polarizer 202, the at least one beam splitter 204, and/or the lens assembly (LA) to be provided to the user's eyes. The order in which light beams pass through the one or more quarter-wave plates 203 and 205, the at least one reflective polarizer 202, the at least one beam splitter 204, and/or the lens assembly (LA) may be configured in various ways depending on embodiments.

According to an embodiment, a first quarter-wave plate 203 and the reflective polarizer 202 may be disposed on the user's eye side surface of the two surfaces of the first lens L1 (hereinafter, referred to as a “first lens L1”) from the user's eyes E in the lens assembly LA, and the beam splitter 204 may be disposed on one of the two surface of the first lens L1 or the second lens L2 (hereinafter, referred to as a “second lens L2”) from the user's eyes E. For example, in the illustrated embodiment, the beam splitter 204 may be disposed on the display side surface of the second lens L2, and in the embodiment described later, the beam splitter may be disposed on the display side surface of the first lens L1. Here, “disposed on XX” may refer to being disposed adjacent to or substantially in contact with XX. For example, the beam splitter 204 may be disposed adjacent to the display side surface of the first lens L1 or the second lens L2, or may be provided substantially in contact with the display side surface of the first lens L1 or the second lens L2.

In the illustrated embodiment, among the plurality of lenses (e.g., at least four lenses), the first lens L1 of the wearable electronic device 300 or the lens assembly (LA) may be understood as the lens disposed furthest from the display D or the lens disposed closest to the user's eyes E. It is to be noted, however, that the embodiment(s) of the disclosure are not limited thereto. For example, although not illustrated, the wearable electronic device 300 or the lens assembly (LA) may further include a transmissive optical member disposed farther from the display D than the first lens L1. In an embodiment, the transmissive optical member may have a refractive power that does not affect the optical performance of the lens assembly (LA). In an embodiment, the transmissive optical member disposed farther from the display D than the first lens L1 may have a transmittance of approximately 90% or more for visible light beams. In an embodiment, the transmissive optical member may have a transmittance close to 100% for visible light beams. In the illustrated embodiment, reference numeral “201” is indicated to exemplify a first polarizer, but in an embodiment, the first polarizer may be omitted. In a structure in which the first polarizer is omitted, reference number “201” may be understood as indicating the above-described transmissive optical member. In an embodiment, the transmissive optical member may be disposed between the first lens L1 and the first polarizer 201 or between the reflective polarizer 202 and the first polarizer 201.

FIG. 5 exemplifies that the first quarter-wave plate 203 and/or the reflective polarizer 202 are disposed adjacent to (or substantially in contact with) the user's eye side surface of the user of the two surfaces of the first lens L1, and that the beam splitter 204 is disposed adjacent to (or substantially in contact with) the display side surface of the second lens L2 (or the first lens L1). In an embodiment, the reflective polarizer 202 may be configured in the form of a film, laminated with the first quarter-wave plate 203 to form a first film section F1, and attached to the first lens L1 from the user's eyes. Here, the term “laminated” may mean that two different members is bonded to each other with an adhesive provided on at least one of the members. In an embodiment, when the first quarter-wave plate 203 and/or the reflective polarizer 202 is disposed in contact with a lens (e.g., the first lens L1) (e.g., when attached to one surface of the first lens L1), of the surfaces of the first lens L1, the surface which is in contact with the first quarter-wave plate 203 and/or the reflective polarizer 202 may be implemented as substantially a flat surface.

According to an embodiment, the first film section F1 in the form in which the first quarter-wave plate 203 and the reflective polarizer 202 are laminated may be thinner and have more excellent optical performance than the film section with a simple stacked structure. According to an embodiment, as illustrated in FIG. 5, the wearable electronic device 300, the lens assembly LA, and/or the first film section F1 may further include at least one separately provided polarizing film (e.g., the first polarizer 201), and may further include at least one anti-reflection (AR) film (not illustrated) in addition to or in place of the polarizing film. In an embodiment, when the wearable electronic device 300 and/or the lens assembly (LA) further includes a transmissive optical member (not illustrated), the transmissive optical member may be disposed between the reflective polarizer 202 and the first polarizer 201. For example, the first polarizer 201 may be understood as a part of the first film section F1 or as a component independent of the first film section F1.

According to an embodiment, a liquid crystal display, organic light-emitting diode display, and/or micro LED may provide good quality images by including a polarizer. In an embodiment, when the lens assembly (LA) further includes the first film section F1 and/or the first polarizer 201, the image quality recognized by the user may be enhanced even when the display D outputs an image of the same quality. In an embodiment, when a display implemented with an organic light-emitting diode display or micro LED is combined with the lens assembly (LA) including the first film section F1, the second film section F2, and/or the first polarizer 201, some polarizers may be omitted from the display D. In an embodiment, the lens assembly (LA) may include the first film section F1 and/or the first polarizer 201, and the display D may include a polarizer.

According to an embodiment, the first film section F1 (or a polarizing plate) may be disposed closer to the user's eyes E than the lens assembly (LA) to selectively transmit, reflect, and/or block light beams (e.g., the light beams output from the display D) entering the user's eyes. The beam splitter 204 may be disposed between the lenses of the lens assembly (LA), for example, between the first lens L1 and the second lens L2 or between the second lens L2 and the third lens L3. The beam splitter 204 may be configured to transmit some of the light beams incident on the beam splitter 204 and reflect the remainder of the incident light beams. For example, the beam splitter 204 may be configured to transmit about 50% of the light beams and reflect about 50% of the light beams. In an embodiment, the beam splitter 204 may be made of, for example, a semi-transparent mirror, and may be fabricated in the form of a mirror obtained by applying coating to one surface of the first lens L1 or the second lens L2. Hereinafter, based on the functional aspect in which light beams are reflected, the reflective polarizer 202 may be referred to as a “first reflective member” and the beam splitter 204 may be referred to as a “second reflective member”.

In the following description, the direction oriented from the user's eyes E to the display D may be referred to as a first direction, and the direction oriented from the display D to the user's eyes E, opposite to the first direction, may be referred to as a second direction. The first direction and the second direction may be substantially parallel to the optical axis O. The lens assembly (LA) may include a plurality of lenses (e.g., the first lens L1, the second lens L2, the third lens L3, and the fourth lens L4) sequentially arranged along the first direction.

According to an embodiment, the wearable electronic device 300 may include a second film section F2 disposed at a position farther from the user's eyes E than the lens assembly (LA) to selectively transmit, reflect, and/or block light beams entering the lens assembly (LA). In the illustrated embodiment, the second film section F2 may be disposed between the display D and the lens assembly (LA) (e.g., the fourth lens L4). However, the embodiments of the disclosure are not limited to this, and the second film section F2 may be disposed at any position between the display D and the first lens L1 or at any position between the display D and the first film section F1.

According to an embodiment, the second film section F2 may include a second quarter-wave plate 205 and a second polarizer 206. Similar to the first film section F1, the second quarter-wave plate 205 and the polarizer 206 may be combined to form the second film section F2. As mentioned above, for the purpose of distinguishing components, the quarter-wave plate 203 of the above-described first film section F1 may be referred to as a first quarter-wave plate 203, and the quarter-wave plate 205 of the second film section F2 may be referred to as a second quarter-wave plate 205. In addition, the polarizer 206 of the second film section F2 may be referred to as a second polarizer 206 to distinguish it from the first polarizer 201 included in the first film section F1.

According to an embodiment, the arrangement of the film sections F1 and F2 and/or the beam splitter 204 may provide good quality images while downsizing an optical system implemented with a limited number of lenses (e.g., about 4 lenses). For example, by reducing the number of lenses (or the number of lens surfaces) disposed between the reflective polarizer 202 as the first reflective member and the beam splitter 204 as the second reflective member, it is possible to suppress refraction or scattering in the path of reflected light beams, and/or birefringence due to manufacturing errors.

According to an embodiment, the wearable electronic device 300 may operate as follows. The light beams output from the display D may pass through the second film section F2, the lens assembly (LA), and the first film section F1 before reaching the user's eyes E. At this time, the second polarizer 206 of the second film section F2 transmits a first linearly polarized light beam, for example, a vertically polarized light beam (or a p-polarized light beam), and may not transmit a second linearly polarized light beam, for example, a horizontally polarized light beam (or an s-polarized light beam). For example, among the light beams reaching the second polarizer 206, only vertically polarized light beams (or p-polarized light beams) can be transmitted. The light beams passing through the second polarizer 206 may be converted into circularly polarized light beams (right-circularly polarized light beams or left-circularly polarized light beams) by the second quarter-wave plate 205, and the circularly polarized light beams may pass through the lens assembly (LA) and the beam splitter 204 and may then reach the first quarter-wave plate 203. The circularly polarized light beams, which reach the first quarter-wave plate 203, may be converted back into linear polarized light beams (e.g., vertically polarized light beams (or p-polarized light beams) while passing through the first quarter-wave plate 203, and may then reach the reflective polarizer 202. The light beams may move in a second direction (from the display D to the user's eyes E) until reaching the reflective polarizer 202. The light beams, which reach the reflective polarizer 202, may be reflected by the reflective polarizer 202 to be directed in the first direction (from the user's eyes E to the display D), and may be then converted into circularly polarized light beams (right-circularly polarized light beams or left-circularly polarized light beams). The circularly polarized light beams (right-circularly polarized beams or left-circularly polarized beams) may be reflected by the beam splitter 204 to be directed in the second direction again, in which case phase conversion may executed (e.g., left-circularly polarized light beams may be converted into light-circularly polarized light beams and right-circularly polarized light beams may be converted into left-circularly polarized light beams). The phase-converted circularly polarized light beams may pass through the first quarter-wave plate 203 and the reflective polarizer 202 along the second direction and reach the user's eyes E. At this time, the light beams passing through the first quarter-wave plate 203 may be converted into horizontally polarized light beams (or s-polarized light beams) and reach the user's eyes E. However, the embodiment of FIG. 5 illustrates a change in the state of light beams passing through the wearable electronic device 300 according to an embodiment by way of an example, in which it is to be noted that the conversion of polarized components by the reflective polarizer 202, the quarter-wave plates 203 and 205, the beam splitter 204, and/or the second polarizer 206 may differ from that of the above-mentioned embodiment.

In the embodiment of FIG. 5, the optical path from the display D to the user's eyes E or the polarized states of light beams passing through (or reflected by) the film sections F1 and F2 or the beam splitter 204 is illustrated. For convenience of explanation regarding the optical path or polarized state, FIG. 5 exemplifies the second film section F2 as being disposed on a fourth lens L4, but the embodiments of the disclosure are not limited thereto. The first film section F1 and the second film section F2 may be disposed between two adjacent lenses (e.g., the first lens L1 and the second lens L2), and the beam splitter 204 may be disposed between the first film section F1 and the second film section F2.

FIG. 6 is a view illustrating a tunable lens TL1 (e.g., at least one of the lenses L1, L2, L3, and L4 in FIG. 5) of a wearable electronic device (e.g., the electronic device 101 in FIG. 1 and/or the wearable electronic device 200 or 300 in FIGS. 2 to 5) according to an embodiment of the disclosure. FIG. 7 is a cross-sectional view of the tunable lens TL1 of the wearable electronic device 300, taken along line A-A′ in FIG. 6 according to an embodiment of the disclosure.

Referring to FIGS. 6 and 7, the tunable lens TL1 may include an optical chamber 13 filled with an electrically conductive liquid and electrode terminals 11a and 11b. The electrically conductive liquid is, for example, substantially transparent and movable in response to an applied electrical signal. In an embodiment, the electrically conductive liquid is movable within the optical chamber 13 by an electrical signal or external force applied to the electrode terminals 11a and 11b. The optical chamber 13 may transmit at least some of visible light beams, and may be deformed in shape depending on the movement or distribution of the electrically conductive liquid. For example, by controlling the shape of the optical chamber 13 by applying an electrical signal to the electrode terminals 11a and 11b, the refractive power or focal length of the optical chamber 13 may be adjusted. In an embodiment, the tunable lens TL1 is provided with at least one of the lenses L1, L2, L3, and L4 of FIG. 5 so that the optical performance of the lens assembly (LA) can be controlled to be suitable for a user's physical condition or wearing state.

According to an embodiment, the electrode terminals may include a first electrode terminal 11a provided as a positive pole and a second electrode terminal 11b provided as a negative pole. In an embodiment, the first electrode terminal 11a and the second electrode terminal 11b may be disposed to face each other and/or face away from each other. In an embodiment, the first electrode terminal 11a may be understood as a structure that has a plate shape and determines the effective diameter of the optical chamber 13. For example, the first electrode terminal 11a may define an opening area through which light is incident on the optical chamber 13, and at least a portion (e.g., an edge portion) of the optical chamber 13 may be disposed between the first electrode terminal 11a and the second electrode terminal 11b. In an embodiment, the second electrode terminal 11b may be made substantially transparent to transmit light beams focused or guided by the first electrode terminal 11a and/or the optical chamber 13. In an embodiment, the first electrode terminal 11a and the second electrode terminal 11b may be disposed to face each other by a spacer 15, and the optical chamber 13 may be disposed between the first electrode terminal 11a and the second electrode terminal 11b in an area that is at least partially surrounded by the spacer 15.

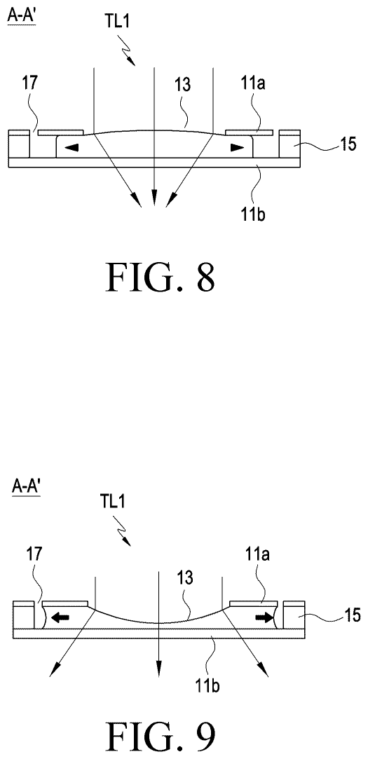

According to an embodiment, as the shape of the optical chamber 13 is changed, the size or volume of the portion disposed between the first electrode terminal 11a and the second electrode terminal 11b of the optical chamber 13 may vary. In an embodiment, the first electrode terminal 11a and/or the second electrode terminal 11b includes at least one ventilation hole 17, thereby allowing the size or volume of the portion of the optical chamber 13 disposed between the first electrode terminal 11a and the second electrode terminal 11b to smoothly vary. For example, since the air within the space where a portion of the optical chamber 13 is to be accommodated is discharged to the outside through the at least one ventilation hole 17, the optical chamber 13 can be easily deformed. The deformation of the optical chamber 13 will be further discussed with reference to FIGS. 8 and 9.

FIG. 8 is a cross-sectional view of the tunable lens TL1 (e.g., at least one of the lenses L1, L2, L3, and L4 in FIG. 5) of a wearable electronic device (e.g., the electronic device 101 in FIG. 1 and/or the wearable electronic device 200 or 300 in FIGS. 2 to 5), taken along line A-A′ in FIG. 6, exemplifying a first operating state of the tunable lens TL1 according to an embodiment of the disclosure. FIG. 9 is a cross-sectional view of the tunable lens TL1 of the wearable electronic device 300, taken along line A-A′ in FIG. 6, exemplifying a second operating state of the tunable lens TL1 according to an embodiment of the disclosure.

Referring further to FIGS. 8 and 9, as an electrical signal is applied to the electrode terminals 11a and 11b, the refractive power or focal length of the tunable lens TL1 may be adjusted while the optical chamber 13 is deformed. For example, depending on the electrical signal applied to the electrode terminals 11a and 11b, the shape or refractive power of the optical chamber 13 may be adjusted while the distribution of the electrically conductive liquid varies. In an embodiment, the tunable lens TL1 may be provided as at least one of the above-described lenses L1, L2, L3, and L4. In an embodiment, the tunable lens TL1 may be provided as the lens closest to the display D among the lenses L1, L2, L3, and L4 (e.g., the fourth lens L4 in FIG. 5). For example, among the lenses L1, L2, L3, and L4 described above, at least the fourth lens L4 may be implemented by the tunable lens TL1. In an embodiment, the lens implemented by the tunable lens TL1 among the lenses L1, L2, L3, and L4 may be disposed closer to the display D than the above-mentioned film sections F1 and F2 or may be disposed farther from the display D than the above-described film sections F1 and F2.

According to an embodiment, when FIG. 7 exemplifies a state in which the optical chamber 13 has a positive refractive power, FIG. 9 may exemplify a state in which the optical chamber 13 has a negative refractive power. FIG. 8 may be understood as exemplifying a state in which the optical chamber 13 has a positive refractive power but a lower refractive power than that in FIG. 7. In an embodiment, the distribution of the liquid can be adjusted and the refractive power of the tunable lens TL1 can be adjusted by forcibly (e.g., mechanically) changing the shape of the optical chamber 13 filled with the transparent liquid. The tunable lens TL1 with this mechanical operation structure may be implemented with reference to Korean Patent Laid-Open Publication No. 10-2023-0012181 (published on Jan. 26, 2023) and U.S. Patent Application Publication No. 2023/0019936 (published on Jan. 19, 2023). When the tunable lens TL1 has the mechanical operation structure, the liquid filled in the optical chamber may not be electrically conductive.

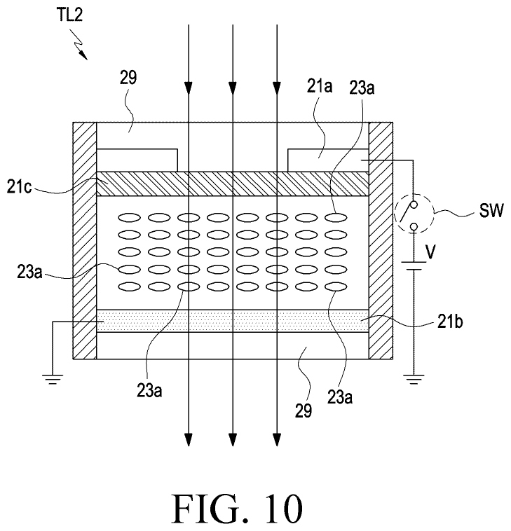

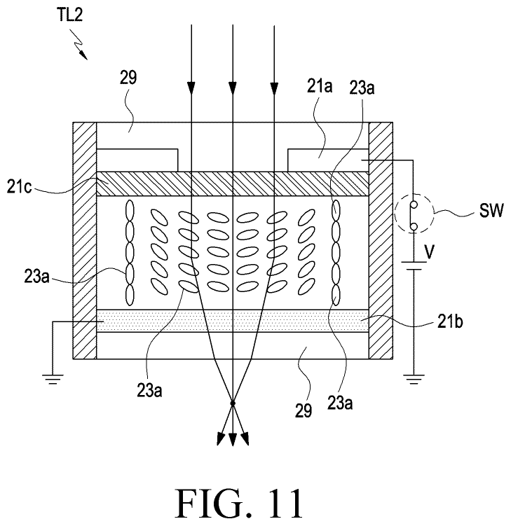

FIG. 10 is a view illustrating a tunable lens TL2 (e.g., at least one of the lenses L1, L2, L3, and L4 in FIG. 5) of a wearable electronic device (e.g., the electronic device 101 in FIG. 1 and/or the wearable electronic device 200 or 300 in FIGS. 2 to 5) according to an embodiment of the disclosure. FIG. 11 is a view exemplifying an operating state of the tunable lens TL2 of a wearable electronic device 300 according to an embodiment of the disclosure.

Referring to FIGS. 10 and 11, the tunable lens TL2 may be provided as at least one of the lenses L1, L2, L3, and L4 described above, and may include transparent plates 29 disposed to face each other, liquid crystals 23a provided in the space between the transparent plates 29, and electrode terminals 21a and 21b configured to apply an electrical signal to the liquid crystals 23a. In an embodiment, of the electrode terminals 21a and 21b, the first electrode terminal 21a, which is a positive pole may be provided above or below the area where the liquid crystals 23a are provided with a transparent insulating layer 21c interposed therebetween, and the second electrode terminal 21b, which is a negative pole, may be provided below or above the area where the liquid crystals 23a are provided. In an embodiment, the second electrode terminal 21b may be disposed in contact with the liquid crystals 23a.

According to an embodiment, the arrangement or orientation of the liquid crystals 23a may be changed depending on the operation of applying an electrical signal to the electrode terminals 21a and 21b (e.g., the on/off operation of a switch SW). This change in arrangement (or orientation) of the liquid crystals 23a may adjust the refractive power of the tunable lens TL2 (e.g., the focal length or refractive performance of the lens assembly (LA) in FIG. 5). In an embodiment, when the switch SW is in the on state, the inclination or arrangement of the liquid crystals 23a may vary depending on the voltage of the applied electrical signal. FIG. 10 illustrates, for example, a state in which the switch SW is off, in which case, the tunable lens TL2 may have substantially no refractive power. FIG. 11 illustrates a state in which the switch SW is on, in which case, the tunable lens TL2 may have a positive refractive power. When the switch is turned on, the refractive power of the tunable lens TL2 may be adjusted depending on the magnitude of the voltage (or intensity of the current) of the electrical signal applied to the electrode terminals 21a and 21b. For example, by varying the voltage (or current) of the electrical signal applied to the electrode terminals 21a and 21b, the refraction function such as the focal length of the tunable lens TL2 and/or the lens assembly (LA) of FIG. 5 may be adjusted.

According to an embodiment, although not illustrated, at least one of the transparent plates 29 disposed to face each other may include a Fresnel structure with a grid pattern. The Fresnel structure may refer to a structure including grooves arranged concentrically on the surface of the at least one transparent plates 29. In an embodiment, the at least one transparent plate 29 including Fresnel structures may be referred to as a Fresnel lens. In an embodiment, the Fresnel lens 29 may provide different refractive performances depending on the shape or spacing of the grooves. For example, it may be useful in suppressing the difference in resolution between the center area and the peripheral area of the lens (e.g., the at least one transparent plate 29). The pattern or shape of the Fresnel structure to suppress resolution deviation on the at least one transparent plate 29 may vary depending on the specifications of the lens assembly to be actually manufactured (e.g., the lens assembly (LA) in FIG. 5) and/or the tunable lens TL2. In an embodiment, when the tunable lens TL2 includes the Fresnel structure, it may be easy to increase the resolution of the peripheral area. This configuration will be discussed again through the embodiments to be described later.

The effects capable of being obtained by the disclosure are not limited to those described above, and other effects not described above may be clearly understood by a person ordinarily skilled in the art to which the disclosure belongs from the descriptions of the above-described embodiments.

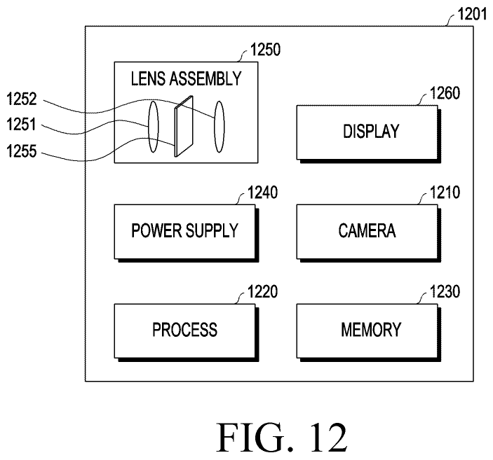

FIG. 12 is a schematic block diagram of a wearable electronic device according to an embodiment of the disclosure.

Referring to FIG. 12, a wearable electronic device 1201 (e.g., the electronic device 101 in FIG. 1 or the wearable electronic device 200 or 300 in FIGS. 2 to 5) may include a camera 1210, a processor 1220, memory 1230, a power supply 1240, a lens assembly 1250, and a display 1260.

According to an embodiment, the processor 1220 may control the overall operation of the wearable electronic device 1201. For example, the processor 1220 may be implemented identically or similarly to the processor 120 of FIG. 1.

According to an embodiment, the processor 1220 may control the display 1260 to output light beams representing visual information through the lens assembly 1250 (e.g., the lens assembly (LA) in FIG. 5). For example, the lens assembly 1250 may be in contact with the display 1260. The display 1260 may include a plurality of pixels. The light beams output from the plurality of pixels included in the display 1260 may pass through the lens assembly 1250 and reach a user's eyes. A user wearing the wearable electronic device 1201 is able to view a visual object or visual information represented by the light beams output from the display 1260.

According to an embodiment, the lens assembly 1250 may include a plurality of lenses 1251 and 1252 (e.g., pancake lenses) and a tunable lens 1255 configured to adjust the refractive index of a light beam (or the phase of a light beam). Meanwhile, FIG. 12 illustrates that the lens assembly 1250 includes only one tunable lens 1255, but this is only for convenience of explanation and the technical idea of the disclosure may not be limited thereto. Depending on implementation, lens assembly 1250 may include a plurality of tunable lenses.

According to an embodiment, the processor 1220 may adjust the refractive index of each of the plurality of areas of the tunable lens 1255. For example, the processor 1220 may apply a predetermined current (or voltage) to each of a plurality of areas of the tunable lens 1255 through the power supply unit (PSU) 1240. When a predetermined current (or voltage) is applied to each of the plurality of areas of the tunable lens 1255, the refractive index of each of the plurality of areas may be adjusted or changed.

In an object (or image) represented by the light beams transmitted through the plurality of lenses 1251 and 1252 included in the lens assembly 1250, the image quality of the area corresponding to the edges or peripheries of the lenses 1251 and 1252 may deteriorate. For example, distortion or blur (or light spread) may be caused in a portion of an object displayed in an area corresponding to the edges or peripheries of the lenses 1251 and 1252. For example, a straight object may be displayed as a curve. Alternatively, the thickness of a line included in the object may be changed.

In order to solve the above problem, the wearable electronic device 1201 according to an embodiment is capable of reducing distortion or blur of an object displayed in an area corresponding to edges or peripheries of the lenses 1251 and 1252 by adjusting the refractive index of each of the plurality of areas of the tunable lens 1255 (or modulating the phase of a light beam passing through each of the plurality of area of the tunable lens 1255). The operation of adjusting the refractive index of a light beam to be described below may include the operation of modulating the phase of a light beam passing through each of the plurality of areas of the tunable lens 1255. However, for convenience of explanation, herein, this operation will be referred to as the operation of adjusting the refractive index of a light beam.

According to an embodiment, the processor 1220 may adjust the refractive index of a first area of the tunable lens 1255 corresponding to a first distance from the edge (e.g., the outermost portion) of the tunable lens 1255 to a first value. The processor 1220 may adjust the refractive index of a second area of the tunable lens 1255 corresponding to a second distance, which is longer than the first distance, from the edge of the tunable lens 1255 to a second value. For example, the first area may be an area corresponding to the periphery of the tunable lens 1255. The second area may be an area corresponding to the center of the tunable lens 1255.

According to an embodiment, the processor 1220 may identify or monitor the gaze of a user wearing the wearable electronic device 1201 through the camera 1210. For example, the camera 1210 may be implemented as a camera for tracking the user's gaze (e.g., an eye tracking camera or an eye tracker). The wearable electronic device 1201 may further include a plurality of optical elements (not illustrated) to facilitate tracking when tracking the user's gaze. For example, a plurality of optical elements may be disposed outside the lens assembly 1250. For example, the plurality of optical elements may output infrared light to the user's eyes so that the camera 1210 can easily track the user's gaze.

According to an embodiment, the processor 1220 may adjust the refractive index of each of the first and second areas of the tunable lens 1255 based on the user's gaze (e.g., the gaze direction or gaze angle).

According to an embodiment, the processor 1220 may use the camera 1210 to identify the angle corresponding to the user's gaze. For example, the processor 1220 may identify a first angle corresponding to the user's gaze with reference to the angle when the user gazes straight ahead. For example, the processor 1220 may configure the angle when the user looks straight ahead as a reference angle (e.g., 0 degrees). The processor 1220 may identify the first angle corresponding to the user's gaze with reference to the reference angle.

According to an embodiment, the processor 1220 may compare the first angle corresponding to the user's gaze with a threshold. For example, the threshold may be an angle value predetermined to identify whether the user's gaze points to a specific area of the tunable lens 1255. For example, the processor 1220 may adjust the refractive index of the first area of the tunable lens 1255 to the first value based on identifying that the first angle corresponding to the user's gaze is greater than a first threshold. At this time, the first value may be a value for increasing the resolution of a visual object displayed in an area corresponding to the first area (e.g., the edge area) and reducing the blur of the visual object. The processor 1220 may control the power supply 1240 to apply a predetermined first current to the first area of the tunable lens 1255. For example, the predetermined first current may mean a current for changing the refractive index of the first area to the first value.

According to an embodiment, the processor 1220 may adjust the refractive index of the first area of the tunable lens 1255 to an initial value based on identifying that the first angle corresponding to the user's gaze is not greater than the first threshold. For example, the initial value may mean the refractive index in the state in which no current is applied to the tunable lens 1255 (e.g., in a transparent glass state). Alternatively, the initial value may mean a refractive index when a predetermined current is applied only to a portion of the first area.

According to an embodiment, the processor 1220 may adjust the refractive index of the second area (e.g., the central area) of the tunable lens 1255 to a second value based on identifying that the first angle corresponding to the user's gaze is greater than the first threshold. At this time, the second value may be a value for increasing the resolution of a visual object displayed in the area corresponding to the first area and reducing the blur of the visual object. The processor 1220 may control the power supply 1240 to apply a predetermined second current to the second area of the tunable lens 1255. Alternatively, the processor 1220 may configure the refractive index of the second area of the tunable lens 1255 to an initial value. For example, the initial value may mean the refractive index in the state in which no current is applied to the tunable lens 1255 (e.g., in a transparent glass state). Alternatively, the initial value may mean a refractive index when a predetermined current is applied only to a portion of the second area.

According to an embodiment, the processor 1220 may adjust the refractive index of the first area by using a table stored in the memory 1230 (e.g., the memory 130 in FIG. 1). For example, when the first angle corresponding to the user's gaze is identified as being greater than the first threshold, the processor 1220 may adjust the refractive index of the first area by applying a current previously determined in the table to the first area. Alternatively, when the first angle corresponding to the user's gaze is identified as not being greater than the first threshold, the processor 1220 may configure the refractive index of the first area to an initial value by applying a current previously determined in the table to the first area.

Through the above-described method, the processor 1220 may increase the resolution of a first object displayed based on first light beams passing through the first area (or first field) of the tunable lens 1255 corresponding to the first distance from the edge of the tunable lens 1255 (e.g., the edge area of the tunable lens), and reduce the blur of the first object.

Meanwhile, at least some of the operations of the wearable electronic device 1201 to be described below may be performed by the processor 1220. However, for convenience of explanation, the wearable electronic device 1201 will be described as performing the corresponding operations.

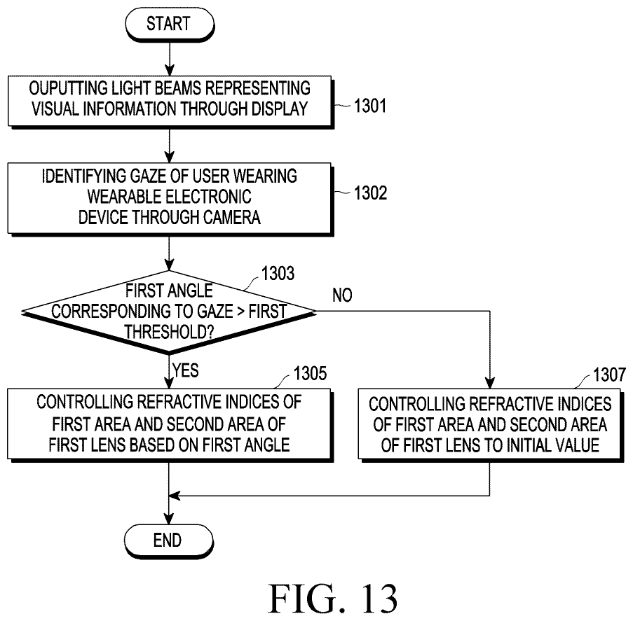

FIG. 13 is a flowchart illustrating an operation in which a wearable electronic device adjusts the refractive index of a tunable lens (hereinafter, referred to as a first lens) based on a user's gaze according to an embodiment of the disclosure.

Referring to FIG. 13, according to an embodiment, in operation 1301, a wearable electronic device (e.g., the wearable electronic device 1201 in FIG. 12) may outputs light beams representing visual information through a display (e.g., the display 1260 in FIG. 12). For example, the light beams may pass through a plurality of lenses 1251 and 1252 included in a lens assembly (e.g., the lens assembly 1250 in FIG. 12) and a first lens (e.g., the tunable lens 1255 in FIG. 12) of which the refractive index can be adjusted by applying an electrical signal, and reach a user's eyes.

According to an embodiment, in operation 1302, the wearable electronic device 1201 may identify the gaze of a user wearing the wearable electronic device 1201 through a camera (e.g., the face recognition camera modules 325 and 326 in FIG. 4 and the camera 1210 in FIG. 12). The wearable electronic device 1201 may identify a first angle corresponding to the user's gaze. For example, the wearable electronic device 1201 may configure the angle when the user gazes straight ahead as a reference angle. The wearable electronic device 1201 may identify the first angle represented by the user's gaze based on the reference angle.

According to an embodiment, in operation 1303, the wearable electronic device 1201 may identify whether the first angle corresponding to the user's gaze is greater than a first threshold. For example, the first threshold may be an angle value for identifying whether the user's gaze deviates from the center of the first lens 1255.

According to an embodiment, when the first angle corresponding to the user's gaze is identified as being greater than the first threshold (example of operation 1303), in operation 1305, the wearable electronic device 1201 may control or adjust the refractive indices of the first area and the second area of the first lens 1255 (the phases of light beams passing through the first area and the second area) based on the first angle. For example, when the user's gaze is identified as being directed toward the peripheral portion or edge portion of the first lens 1255, the wearable electronic device 1201 may adjust the refractive indices of the first and second areas of the first lens 1255. Through this, the wearable electronic device 1201 may increase the resolution of the object represented by the light beams passing through the edge area of the first lens 1255 and reduce the blur (e.g., optical blur) of the object.

According to an embodiment, when the first angle corresponding to the user's gaze is identified as not being greater than the first threshold (“No” in operation 1303), in operation 1307, the wearable electronic device 1201 may control the refractive indices of the first area and the second area to an initial value. For example, when the user's gaze is identified as being directed toward the middle portion or central area of the first lens 1255, the wearable electronic device 1201 may configured the refractive indices of the first and second areas of the first lens 1255 to the initial value. Since the resolution of the object represented by the light beams passing through the central area of the first lens 1255 is good, the wearable electronic device 1201 may minimize power consumption when the user's gaze is looking straight ahead. For example, the first lens 1255 controlled to the initial value may be transparent glass. Alternatively, the first lens 1255 controlled to the initial value may be in a state in which a partial area (e.g., a partial edge area) is controlled.

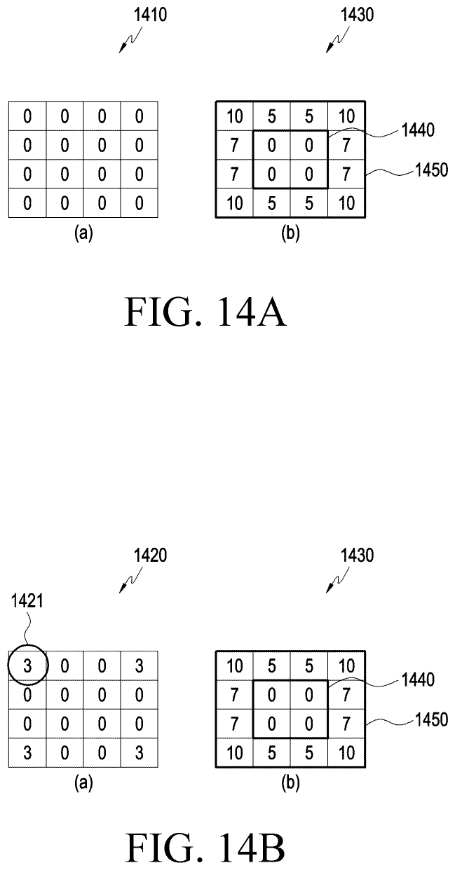

FIGS. 14A and 14B are views illustrating a method of adjusting a refractive index of a tunable lens (or a first lens) by a wearable electronic device according to various embodiments of the disclosure.

Referring to FIGS. 14A and 14B, the wearable electronic device 1201 may control the refractive index of each of a plurality of areas by applying a predetermined current to each of a plurality of areas (a plurality of fields) of the first lens (e.g., the tunable lens 1255 in FIG. 12).

Referring to part (a) of FIG. 14A, according to an embodiment, a first current map 1410 may be a current map when a user's gaze is directed toward the central portion of the first lens 1255. For example, the wearable electronic device 1201 may not apply any current to the first lens 1255 as the initial value of the first lens 1255, as in the first current map 1410. At this time, the first lens 1255 may be transparent glass. Referring to part (a) of FIG. 14B, according to an embodiment, the wearable electronic device 1201 may apply a current predetermined to a partial area 1421 of the first lens 1255 as the initial value of the first lens 1255. At this time, the refractive index of the edge portion of the first lens 1255 (e.g., the portion corresponding to 1421) may be changed.

Referring to part (b) of FIG. 14A (or part (b) of FIG. 14B), according to an embodiment, a second current map 1430 may be a current map when the user's gaze is directed toward the edge portion of the first lens 1255. For example, the wearable electronic device 1201 may adjust the refractive index of a first area 1450 by applying a current to the first area 1450 of the first lens as in the second current map 1430. In addition, the wearable electronic device 1201 may not apply any current to a second area 1440 as in the second current map 1430. At this time, the second area 1440 may be transparent glass. Depending on implementation, currents with different magnitudes may be applied to a plurality of areas included in the first area 1450. That is, the wearable electronic device 1201 may apply different currents depending on the positions of the plurality of areas included in the first area 1450. Alternatively, a current with the same magnitude may be applied to a plurality of areas included in the first area 1450.

According to an embodiment, the first current map 1410 or 1420 and the second current map 1430 may be stored in advance in memory (e.g., the memory 1230 in FIG. 12). The wearable electronic device 1201 may adjust the refractive index of the first lens 1255 by reading the corresponding current map according to the user's gaze.

According to the above-described method, the wearable electronic device 1201 may adjust the refractive index of each of a plurality of areas of the first lens 1255 by applying currents with predetermined magnitudes to the first area 1450 and the second area 1440 of the first lens 1255 depending on the user's gaze. Through this, the wearable electronic device 1201 may increase the resolution of the first object displayed based on first light beams passing through the first area (e.g., the edge area) of the first lens 1255 and reduce the blur of the first object.

Meanwhile, the current values applied to the first lens 1255 in FIGS. 14A and 14B are exemplary, and the technical idea of the disclosure may not be limited thereto.

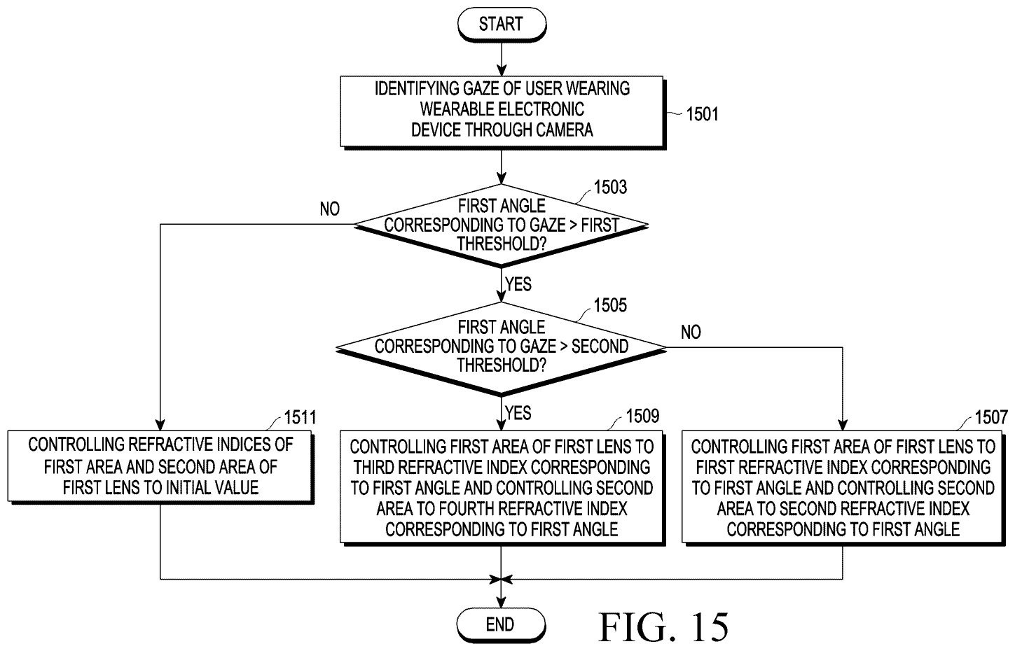

FIG. 15 is a flowchart illustrating an operation of adjusting the refractive index of a tunable lens (or a first lens by a wearable electronic device according to an embodiment of the disclosure.

Referring to FIG. 15, according to an embodiment, in operation 1501, a wearable electronic device (e.g., wearable electronic device 1201 in FIG. 12) may identify the gaze of a user wearing the wearable electronic device 1201 through a camera (e.g., the camera 1210 in FIG. 12).

According to an embodiment, in operation 1503, the wearable electronic device 1201 may identify whether a first angle corresponding to the user's gaze is greater than a first threshold. For example, the first threshold (e.g., about 30 degrees) may be an angle value for identifying whether the user's gaze is directed toward the central portion of the first lens 1255 (e.g., the portion corresponding to 0 to 0.3° F.) of the lens 1255.

According to an embodiment, when the first angle corresponding to the user's gaze is identified as not being greater than the first threshold (“No” in operation 1503), in operation 1511, the wearable electronic device 1201 may control the refractive indices of the first area and the second area of the first lens 1255 to an initial value.

According to an embodiment, when the first angle corresponding to the user's gaze is identified as being greater than the first threshold (“Yes” in operation 1503), in operation 1505, the wearable electronic device 1201 may identify whether the first angle corresponding to the user's gaze is greater than a second threshold. For example, the second threshold (e.g., about 70 degrees) may be an angle value for identifying whether the user's gaze is directed toward a middle portion (e.g., the portion corresponding to 0.3° F. to 0.7° F.) or the peripheral portion (e.g., the portion corresponding to 0.7° F. to 1.0° F.) of the first lens 1255. The second threshold may be greater than the first threshold.

According to an embodiment, when the first angle corresponding to the user's gaze is identified as not being greater than the second threshold (“No” in operation 1505), in operation 1507, the wearable electronic device 1201 may control the first area of the first lens 1255 to a first refractive index corresponding to the first angle and control the second area to a second refractive index corresponding to the first angle. For example, the first refractive index and the second refractive index may be determined as values at which the resolution of the object represented by the light beams passing through the middle portion (e.g., the portion between the central portion and the peripheral portion) of the first lens 1255 increases and the blur of the object decreases.

According to an embodiment, when the first angle corresponding to the user's gaze is identified as being greater than the second threshold (“Yes” in operation 1505), in operation 1509, the wearable electronic device 1201 may control the first area of the first lens to a third refractive index corresponding to the first angle and control the second area to a fourth refractive index corresponding to the first angle. For example, the third refractive index and the fourth refractive index may be determined as values at which the resolution of an object represented by the light beams passing through the peripheral portion of the first lens 1255 increases and the blur of the object decreases.

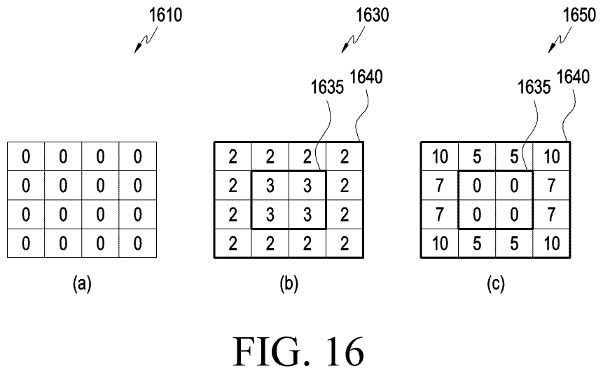

FIG. 16 is a view illustrating a method of adjusting the refractive index of a tunable lens (or a first lens) by a wearable electronic device according to an embodiment of the disclosure.

Referring to (a) of FIG. 16, according to an embodiment, a first current map 1610 may be a current map when a user's gaze is directed toward the central portion of the first lens 1255. For example, the wearable electronic device 1201 may not apply any current to the first lens 1255 as the initial value of the first lens 1255, as in the first current map 1610. At this time, the first lens 1255 may be transparent glass.

Referring to (b) of FIG. 16, according to an embodiment, a second current map 1630 may be a current map when a user's gaze is directed toward a middle portion (e.g., the portion between the central portion and the peripheral portion) of the first lens 1255. For example, the wearable electronic device 1201 may adjust the refractive index of a first area 1640 by applying a predetermined current to the first area 1640 of the first lens as in the second current map 1630. In addition, the wearable electronic device 1201 may not apply a predetermined current to a second area 1635 as in the second current map 1630. At this time, the magnitude of the current applied to the first area 1640 and the magnitude of the current applied to the second area 1635 may be different.

Referring to (c) of FIG. 16, according to an embodiment, a third current map 1650 may be a current map when the user's gaze is directed toward an edge portion of the first lens 1255. For example, the wearable electronic device 1201 may adjust the refractive index of the first area 1640 by applying a predetermined current to the first area 1640 of the first lens as in a third current map 1650. In addition, the wearable electronic device 1201 may not apply any current to the second area 1635 as in the third current map 1650. At this time, the second area 1635 may be transparent glass. Currents with different magnitudes may be applied to a plurality of areas included in the first area 1640. That is, the wearable electronic device 1201 may apply different currents depending on the positions of the plurality of areas included in the first area 1640. Alternatively, the wearable electronic device 1201 may apply a current with the same magnitude to a plurality of areas included in the first region 1640.

According to an embodiment, the first current map 1610, the second current map 1630, and the third current map 1650 may be stored in advance in memory (e.g., the memory 1230 in FIG. 12). The wearable electronic device 1201 may adjust the refractive index of the first lens 1255 by reading the corresponding current map according to the user's gaze.

According to the above-described method, the wearable electronic device 1201 may adjust the refractive index of each of a plurality of areas of the first lens 1255 by applying currents with predetermined magnitudes to the first area 1640 and the second area 1635 of the first lens 1255 depending on the user's gaze. Through this, the wearable electronic device 1201 may increase the resolution of the first object displayed based on first light beams passing through the first area (e.g., the edge area) of the first lens 1255 and reduce the blur of the first object.

Meanwhile, the current values applied to the first lens 1255 in (a) of FIG. 16 to (c) of FIG. 16 are examples only, and the technical idea of the disclosure may not be limited thereto. For example, current values applied to the first lens 1255 may be determined to have optimal phases.

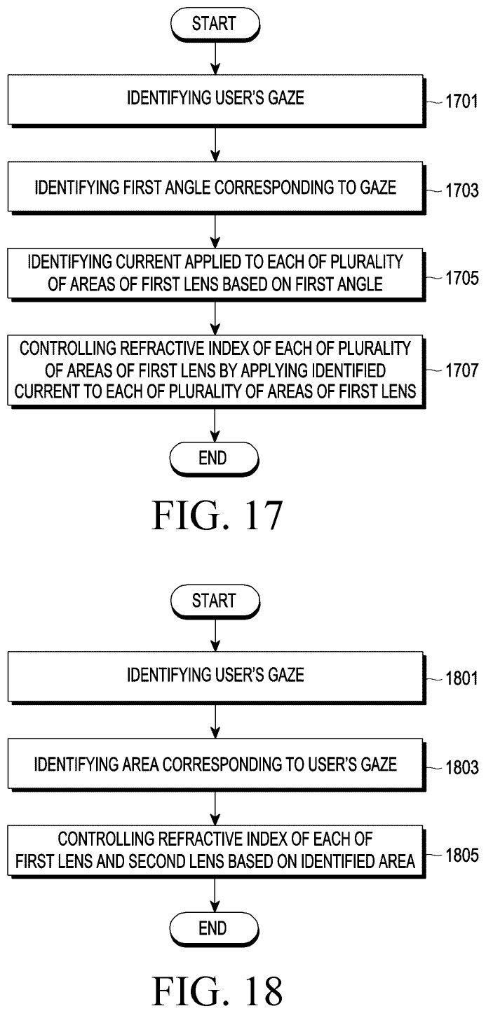

FIG. 17 is a flowchart illustrating an operation of dynamically adjusting the refractive index of a tunable lens (hereinafter, referred to as a first lens) in which a wearable electronic device based on an angle corresponding to a user's gaze according to an embodiment of the disclosure.

Referring to FIG. 17, according to an embodiment, in operation 1701, a wearable electronic device (e.g., wearable electronic device 1201 in FIG. 12) may identify the gaze of a user wearing the wearable electronic device 1201 by using a camera (e.g., the camera 1210 in FIG. 12).

According to an embodiment, in operation 1703, the wearable electronic device 1201 may identify or determine a first angle corresponding to the user's gaze.

According to an embodiment, in operation 1705, the wearable electronic device 1201 may identify a current (or a voltage) to be applied to each of a plurality of areas of the first lens (e.g., the tunable lens 1255 in FIG. 12) based on the first angle. For example, the wearable electronic device 1201 may calculate or identify a current (or a voltage) to be applied to each of the plurality of areas of the first lens 1255 in real time based on the first angle instead of a predetermined current map.

According to an embodiment, in operation 1707, the wearable electronic device 1201 may apply the identified current (or voltage) to each of the plurality of areas of the first lens 1255 to control the refractive index of each of the plurality of areas of the first lens 1255 (or the phases of light beams passing through the plurality of areas of the first lens 1255).

FIG. 18 is a flowchart illustrating an operation of adjusting the refractive indices of a plurality of tunable lenses (or a first lens and a second lens) by a wearable electronic device according to an embodiment of the disclosure.

Referring to FIG. 18, a wearable electronic device (e.g., wearable electronic device 1201 in FIG. 12) may include a lens assembly (e.g., the lens assembly 1250 in FIG. 12) including a plurality of tunable lenses (hereinafter, a first lens and a second lens).

According to an embodiment, in operation 1801, the wearable electronic device 1201 may identify the gaze of a user wearing the wearable electronic device 1201 by using a camera (e.g., the camera 1210 in FIG. 12).

According to an embodiment, in operation 1803, the wearable electronic device 1201 may identify an area corresponding to the user's gaze. For example, the wearable electronic device 1201 may identify or determine an area toward which the user's gaze is directed based on the first angle corresponding to the user's gaze.

According to an embodiment, in operation 1805, the wearable electronic device 1201 may control or adjust the refractive index of each of the first lens and the second lens based on the identified area. For example, the wearable electronic device 1201 may control the refractive index of each of the plurality of areas of the first lens and control the refractive index of each of the plurality of regions of the second lens based on the identified area. To this end, the wearable electronic device 1201 may apply a predetermined current to each of the plurality of areas of the first lens and apply a predetermined current to each of the plurality of areas of the second lens.

According to the above-described method, the wearable electronic device 1201 may appropriately adjust the refractive index of each of the plurality of tunable lenses (e.g., the first lens and the second lens) depending on the user's gaze. Through this, the wearable electronic device 1201 may increase the resolution of the first object displayed based on first light beams passing through the first area (e.g., the edge area) of each of the plurality of tunable lenses and reduce the blur of the first object.

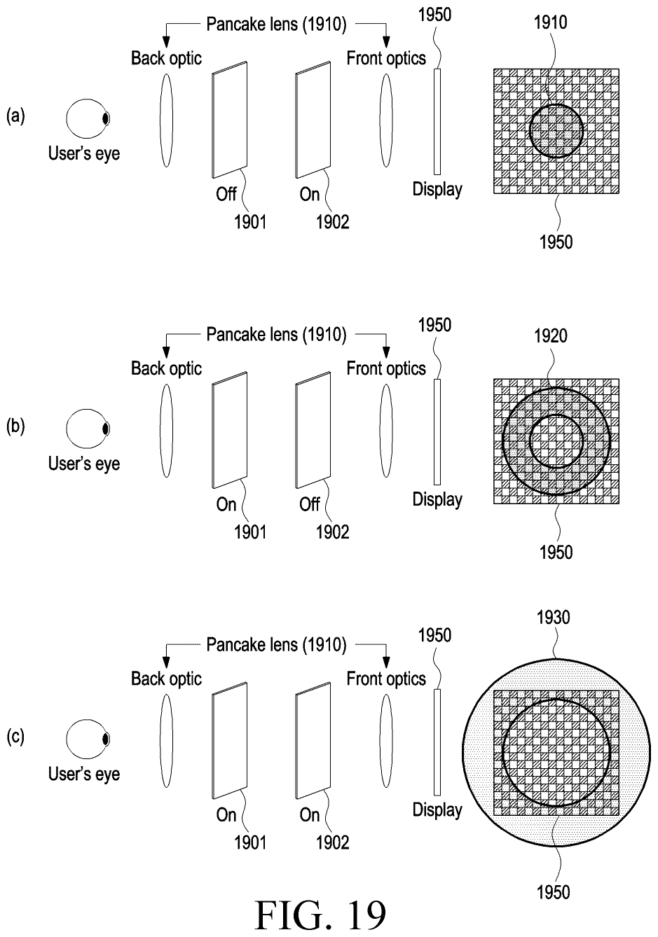

FIG. 19 is a view illustrating an operation of adjusting the refractive indices of a plurality of tunable lenses (or a first lens and a second lens) by a wearable electronic device according to an embodiment of the disclosure.

Referring to FIG. 19, according to an embodiment, a lens assembly (e.g., the lens assembly 1250 in FIG. 12) may include a plurality of pancake lenses 1910 and a plurality of tunable lenses (hereinafter, a first lens 1901 and a second lens 1902).

Referring to (a) of FIG. 19, according to an embodiment, a wearable electronic device (e.g., the wearable electronic device 1201 in FIG. 12) may identify a user's gaze directed toward a front portion 1910 (e.g., the central portion) of the display 1950. The wearable electronic device 1201 may turn off the first lens 1901 and turn on the second lens 1902. For example, the wearable electronic device 1201 may not apply any current to a plurality of areas of the first lens 1901. In addition, the wearable electronic device 1201 may apply a predetermined current to each of a plurality of areas of the second lens 1902 to adjust the refractive index of each of the plurality of areas of the second lens 1902. Through this, the wearable electronic device 1201 may increase the resolution of an object displayed on the front portion 1910 and reduce the blur of the object.

Referring to (b) of FIG. 19, according to an embodiment, the wearable electronic device (e.g., the wearable electronic device 1201 in FIG. 12) may identify the user's gaze directed toward a middle portion 1920 of the display 1950. The wearable electronic device 1201 may turn on the first lens 1901 and turn off the second lens 1902. For example, the wearable electronic device 1201 may not apply any current to the plurality of areas of the second lens 1902. In addition, the wearable electronic device 1201 may apply a predetermined current to each of the plurality of areas of the first lens 1901 to adjust the refractive index of each of the plurality of areas of the first lens 1901. Through this, the wearable electronic device 1201 may increase the resolution of an object displayed on the middle portion 1920 and reduce the blur of the object.

Referring to (c) of FIG. 19, according to an embodiment, the wearable electronic device (e.g., the wearable electronic device 1201 in FIG. 12) may identify the user's gaze directed toward a peripheral portion 1930 of the display 1950. The wearable electronic device 1201 may turn on the first lens 1901 and turn on the second lens 1902. For example, the wearable electronic device 1201 may apply a predetermined current to each of the plurality of areas of the first lens 1901 to adjust the refractive index of each of the plurality of areas of the first lens 1901. In addition, the wearable electronic device 1201 may apply a predetermined current to each of a plurality of areas of the second lens 1902 to adjust the refractive index of each of the plurality of areas of the second lens 1902. Through this, the wearable electronic device 1201 may increase the resolution of an object displayed on the peripheral portion 1930 and reduce the blur of the object.

According to the above-described method, the wearable electronic device 1201 may increase the resolution of the first object displayed based on first light beams passing through the lens assembly 1250 and reduce the blur of the first object by turning on/off the first lens 1901 and the second lens 1902 depending on the user's gaze.

Meanwhile, the combination of turning on/off the first lens 1901 and the second lens 1902 in FIG. 19 is example only, and the technical idea of the disclosure may not be limited thereto. Furthermore, the arrangement order or number of the lenses 1901, 1902, and 1910 are merely exemplary, and the technical idea of the disclosure may not be limited thereto.

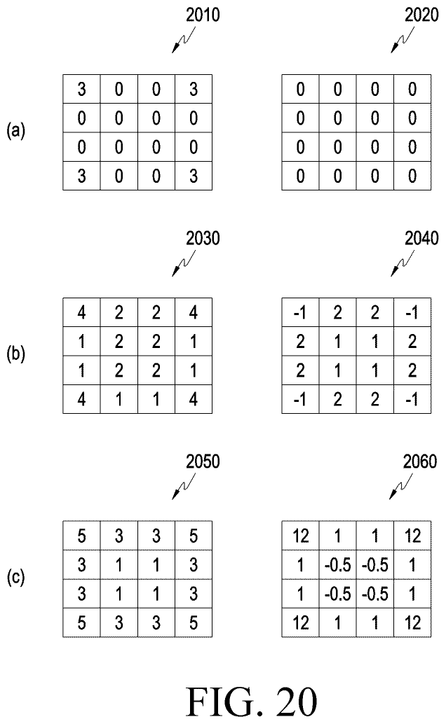

According to another embodiment, when performing the operation illustrated in (a) of FIG. 19, the wearable electronic device 1201 may control the first lens 1901 as in the first current map 2010 in (a) of FIG. 20, and control the second lens 1902 as in the second current map 2020. In addition, when performing the operation illustrated in (b) of FIG. 19, the wearable electronic device 1201 may control the second lens 1902 as in the first current map 2010 in (a) of FIG. 20, and control the first lens 1901 as in the second current map 2020. This will be described in more detail below with reference to FIG. 20.

FIG. 20 is a view illustrating an operation of adjusting the refractive indices of a plurality of tunable lenses (or a first lens and a second lens) by a wearable electronic device according to an embodiment of the disclosure.

Referring to (a) of FIG. 20, according to an embodiment, a first current map 2010 may be a current map when the user's gaze is directed toward the central portion of a first lens (e.g., the first lens 1901 in FIG. 19). The second current map 2020 may be a current map when the user's gaze is directed toward the central portion of a second lens (e.g., the second lens 1902 in FIG. 19). For example, the first current map 2010 may represent a mapping table applied to the first lens 1901 when the first lens 1901 is turned off. For example, the second current map 2020 may represent a mapping table applied to the second lens 1902 when the second lens 1902 is turned off. For example, the wearable electronic device 1201 may not apply any current to the second lens 1902 as the initial value of the second lens 1902, as in the second current map 2020. At this time, the second lens 1902 may be transparent glass. As in the first current map 2010, the wearable electronic device 1201 may apply a predetermined current to some areas (e.g., corner areas) among a plurality of areas of the first lens 1901 as an initial value of the first lens 1901. At this time, the first lens 1901 may provide an optical effect due to a change in the refractive index of the corner areas.

Referring to (b) of FIG. 20, according to an embodiment, a third current map 2030 may be a current map when a user's gaze is directed toward a middle portion (e.g., the portion between the central portion and the peripheral portion) of the first lens 1901. A fourth current map 2040 may be a current map when the user's gaze is directed toward a middle portion (e.g., the portion between the central portion and the peripheral portion) of the second lens 1902. For example, the wearable electronic device 1201 may adjust the refractive index of the first lens 1901 by applying a predetermined current to each of the plurality of areas of the first lens 1901, as in the third current map 2030. In addition, the wearable electronic device 1201 may adjust the refractive index of the second lens 1902 by applying a predetermined current to each of the plurality of areas of the second lens 1902, as in the fourth current map 2040. At this time, the currents, which are applied to the plurality of areas of the first lens 1901, respectively, may have different magnitudes depending on the respective positions of the plurality of areas. In addition, the currents, which are applied to the plurality of areas of the second lens 1902, respectively, may have different magnitudes depending on the respective positions of the plurality of areas. Depending on implementation, the wearable electronic device 1201 may apply a current with a negative value, as in the fourth current map 2040. In this case, the surface of the second lens 1902 may become concave or the phase profile may change to a “negative direction”.

Referring to (c) of FIG. 20, according to an embodiment, a fifth current map 2050 may be a current map when the user's gaze is directed toward a peripheral portion of the first lens 1901. A sixth current map 2060 may be a current map when the user's gaze is directed to the peripheral portion of the second lens 1902. For example, the wearable electronic device 1201 may adjust the refractive index of the first lens 1901 by applying a predetermined current to each of the plurality of areas of the first lens 1901, as in the fifth current map 2050. In addition, the wearable electronic device 1201 may adjust the refractive index of the second lens 1902 by applying a predetermined current to each of the plurality of areas of the second lens 1902, as in the sixth current map 2060. At this time, the currents, which are applied to the plurality of areas of the first lens 1901, respectively, may have different magnitudes depending on the respective positions of the plurality of areas. In addition, the currents, which are applied to the plurality of areas of the second lens 1902, respectively, may have different magnitudes depending on the respective positions of the plurality of areas. For example, in (c) of FIG. 20, the values of currents applied to the first lens 1901 and the second lens 1902, respectively, may differ from those in (b) of FIG. 20. These may be exemplary values configured to adjust the refractive indices of respective lenses 1901 and 1902 depending on the user's gaze. For example, the positions of the areas where negative currents are applied in the sixth current map 2060 may be different from the positions of the areas where negative currents are applied in the fourth current map 2040. In addition, the magnitudes of the negative currents applied in the sixth current map 2060 may be different from the magnitudes of the negative currents applied in the fourth current map 2040.

According to the above-described method, the wearable electronic device 1201 may increase the resolution of the first object displayed based on first light beams passing through the lens assembly 1250 and reduce the blur of the first object by applying predetermined currents to the first lens 1901 and the second lens 1902 depending on the user's gaze.

Meanwhile, the current values applied to the first lens 1901 and the second lens 1902 in FIG. 20 are examples only, and the technical idea of the disclosure may not be limited thereto. For example, the current values applied to the first lens 1901 and the second lens 1902 may be determined as optimal phase combination values.

According to an embodiment, the variable lenses (e.g., the first lens 1901 and the second lens 1902) may be used to adjust the focal distance of the entire field in addition to increasing the resolution of a specific field area. For example, the wearable electronic device 1201 may move the focal length to an arbitrary position by adjusting the current or voltage applied to the variable lens. Through this, the wearable electronic device 1201 may correct the user's eyesight. For example, because eyesight may be different for each user, the wearable electronic device 1201 may obtain (or read) a phase profile of a variable lens optimized for a pre-registered user through a user authentication method. Through this, the wearable electronic device 1201 may configure a focal distance optimized for the user's eyesight.

According to an embodiment, a wearable electronic device 1201 (e.g., a VR device or a video see-through (VST) device) equipped with a multi-focus display module or continuous focus display module in which a VR image or a video see-through (VST) image is not fixed to a single focal plane cannot change the focus positions of all surfaces at once. In this case, the wearable electronic device 1201 may adjust the focal plane of a field corresponding to a gaze-zone the user looks at, in consideration of a value for the user's vision correction (e.g., foveated vision correction concept). To support this, electrodes may be placed on the variable lenses (e.g., the first lens 1901 and the second lens 1902) included in the wearable electronic device 1201 to enable curvature/phase profile adjustment locally rather than concentrically symmetrically.

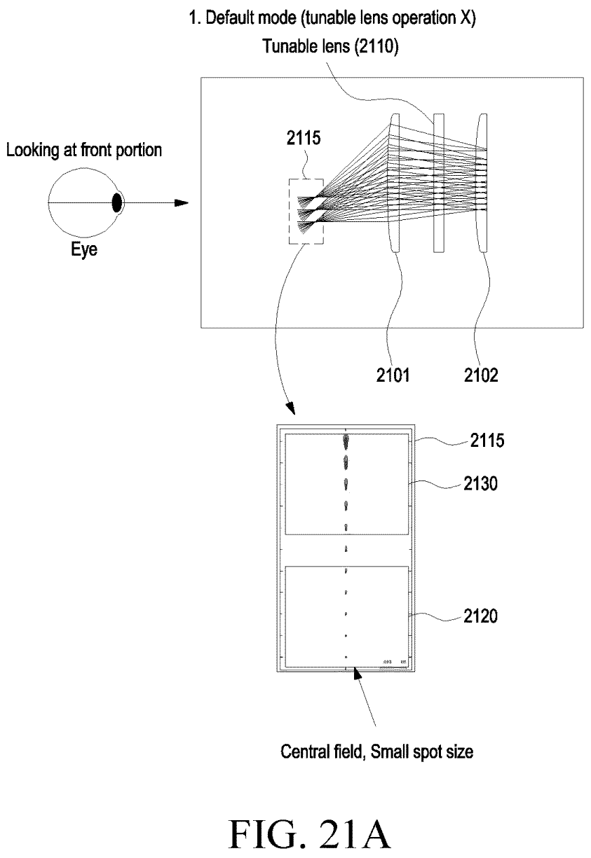

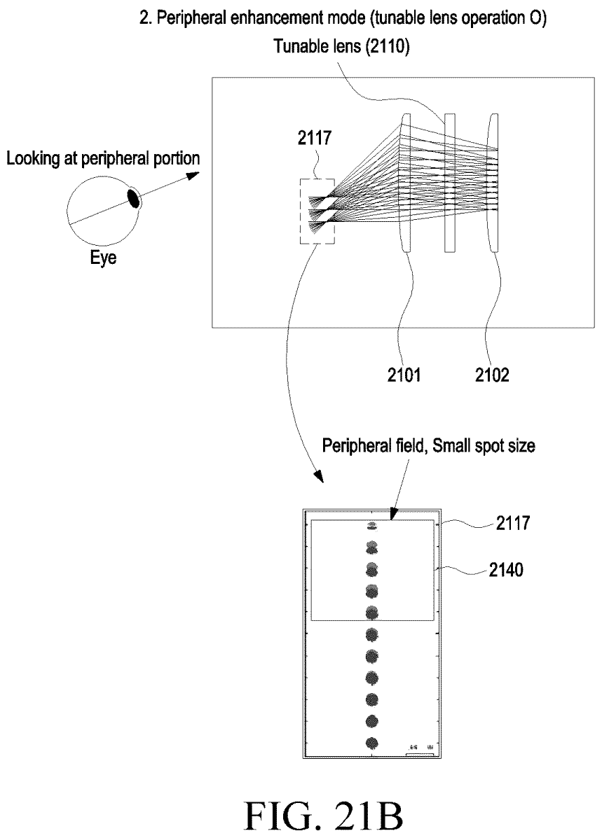

FIG. 21A is a view illustrating an operation of adjusting the refractive index of a tunable lens (or a first lens) by a wearable electronic device when the user's gaze directed toward the front of the lens assembly according to an embodiment of the disclosure.

Referring to FIG. 21A, according to an embodiment, a wearable electronic device (e.g., the wearable electronic device 1201 in FIG. 12) may operate a default mode when the user's gaze is identified as looking at the front. For example, the default mode may refer to the mode in which the tunable lens 2110 included in the lens assembly (e.g., the lens assembly 1250 in FIG. 12) is not operated (e.g., the state in which the refractive index of the tunable lens 2110 is not adjusted).

According to an embodiment, the light beams that pass through the pancake lenses 2101 and 2102 and reach the central field 2120 may have different resolutions depending on the position in the field 2115 where an image is formed.

According to an embodiment, an object represented by the light beams that pass through the pancake lenses 2101 and 2102 and reach the central field 2120 may have a small spot size. That is, an object represented by the light beams that pass through the pancake lenses 2101 and 2102 and reach the central field 2120 may have high resolution. On the other hand, an object represented by the light beams that pass through the pancake lenses 2101 and 2102 and reach the peripheral field 2130 may have a large spot size. That is, an object represented by the light beams that pass through the pancake lenses 2101 and 2102 and reach the peripheral field 2130 may have low resolution.

As described above, when the tunable lens 2110 is not operated (e.g., the refractive index of the tunable lens 2110 is not adjusted), an object represented by light beams that reach the peripheral field 2130 may have low resolution. Therefore, when the user's gaze is directed toward the peripheral field 2130, the wearable electronic device 1201 has no choice but to provide the user with a low-resolution object.

FIG. 21B is a view illustrating an operation of adjusting the refractive index of a tunable lens (or a first lens) by a wearable electronic device when the user's gaze is directed toward an edge of the lens assembly according to an embodiment of the disclosure.

Referring to FIG. 21B, according to an embodiment, a wearable electronic device (e.g., the wearable electronic device 1201 in FIG. 12) may operate a peripheral enhancement mode when the user's gaze is identified as looking at a peripheral portion. For example, the peripheral enhancement mode may refer to the mode in which the tunable lens 2110 included in the lens assembly (e.g., the lens assembly 1250 in FIG. 12) is operated (e.g., the state in which the refractive index of the tunable lens 2110 is adjusted).

According to an embodiment, the light beams that pass through the pancake lenses 2101 and 2102 and reach the central field (e.g., the central field 2120 in FIG. 21A) may have different resolution depending on the position in the field 2117 where an image is formed.

According to an embodiment, an object represented by the light beams that pass through the pancake lenses 2101 and 2102 and the tunable lens 2110 with an adjusted refractive index and reach the peripheral field 2140 may have a small spot size. That is, an object represented by the light beams that pass through the pancake lenses 2101 and 2102 and the tunable lens 2110 with an adjusted refractive index and reach the peripheral field 2140 may have high resolution.

As described above, when the tunable lens 2110 is operated (e.g., a state in which the refractive index or optical phase of the tunable lens 2110 is adjusted), an object represented by the light beams that reach the peripheral field 2140 may have high resolution. Accordingly, even if the user's gaze is directed toward the peripheral field 2140, the wearable electronic device 1201 may provide the user with a high-resolution object.

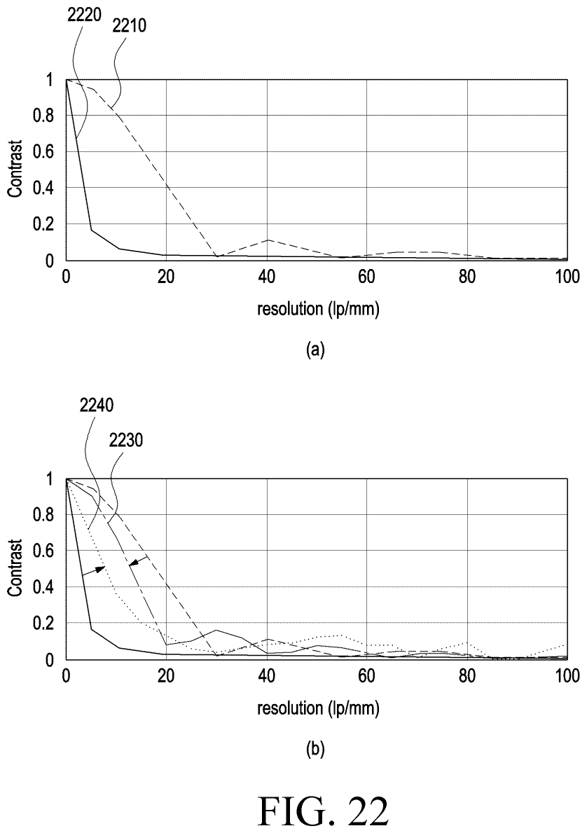

FIG. 22 is a view illustrating diagrams each showing a change in modulation transfer function (MTF) value depending on a change in resolution of a peripheral field of a tunable lens according to an embodiment of the disclosure.

According to an embodiment, (a) of FIG. 22 illustrates graphs showing MTF values (e.g., contrasts) of a central file and a peripheral field of a tunable lens 1255 before compensating for the refractive index (or optical phase) of the tunable lens (e.g., the first lens or the tunable lens 1255 in FIG. 12). According to an embodiment, (b) of FIG. 22 illustrates graphs showing MTF values (e.g., contrasts) of a central file and a peripheral field of a tunable lens 1255 before compensating for the refractive index (or optical phase) of the tunable lens 1255.

According to an embodiment, a first graph 2210 may represent the MTF value of the central field of the tunable lens 1255 before compensating for the refractive index (or optical phase) of the tunable lens 1255.

According to an embodiment, a second graph 2220 may represent the MTF value of the peripheral field of the tunable lens 1255 before compensating for the refractive index (or optical phase) of the tunable lens 1255. For example, the MTF value of the peripheral field of the tunable lens 1255 before compensation may be significantly low.

According to an embodiment, a third graph 2230 may represent the MTF value of the central field of the tunable lens 1255 after compensating for the refractive index (or optical phase) of the tunable lens 1255. For example, the third graph 2230 may indicate that the MTF value is improved compared to that in the first graph 2210.

According to an embodiment, a fourth graph 2240 may represent the MTF value of the peripheral field of the tunable lens 1255 after compensating for the refractive index (or optical phase) of the tunable lens 1255. For example, the fourth graph 2240 may indicate that the MTF value is lowered or maintained compared to that in the second graph 2220.

As described above, when controlling the tunable lens (e.g., adjusting the refractive index or optical phase of the tunable lens 1255 in FIG. 12), an object represented by the light beams reaching the peripheral field may have a higher resolution than that before compensation. Accordingly, even if the user's gaze is directed toward the peripheral field of the tunable lens, the wearable electronic device 1201 may provide the user with a high-resolution object.

According to an embodiment, a wearable electronic device 101, 200, 300, or 1201 may include a camera 1210, a display 160, D, or 1260, a lens assembly LA or 1250 configured to focus or guide light beams representing visual information output from the display, the lens assembly LA or 1250 including a first lens 1255 configured to adjust a refractive index by receiving an electrical signal, at least one processor 1220 and memory (1230) storing instructions. According to an embodiment, the instructions, when executed by the at least one processor, may cause the wearable electronic device to control the display to output the light beams representing the visual information through the lens assembly. According to an embodiment, the instructions, when executed by the at least one processor, may cause the wearable electronic device to adjust a refractive index of a first area of the first lens corresponding to a first distance from an edge of the first lens to reduce blur of a first object displayed based on the first light beams passing through the first area of the first lens corresponding to the first distance from the edge of the first lens. According to an embodiment, the instructions, when executed by the at least one processor, may cause the wearable electronic device to adjust the refractive index of the second area of the first lens to a second value corresponding to a second distance, which is longer than the first distance, from the edge of the first lens.

According to an embodiment, the instructions, when executed by the at least one processor, may cause the wearable electronic device to identify the gaze of a user wearing the wearable electronic device through the camera. According to an embodiment, the processor may be configured to apply a predetermined first current to the first area of the first lens to adjust the refractive index of the first area of the first lens to the first value based on identifying that the first angle corresponding to the gaze is greater than a first threshold.

According to an embodiment, the instructions, when executed by the at least one processor, may cause the wearable electronic device to adjust the refractive index of the first area of the first lens to an initial value based on identifying that the first angle corresponding to the gaze is not greater than a first threshold.

According to an embodiment, the instructions, when executed by the at least one processor, may cause the wearable electronic device to adjust the refractive index of the first area to the initial value by applying a predetermined current to at least a portion of the first area.

According to an embodiment, the instructions, when executed by the at least one processor, may cause the wearable electronic device to apply no current to the first lens based on identifying that a first angle corresponding to the gaze is not greater than a first threshold.

According to an embodiment, the instructions, when executed by the at least one processor, may cause the wearable electronic device to identify the gaze of a user wearing the wearable electronic device through the camera. According to an embodiment, the instructions, when executed by the at least one processor, may cause the wearable electronic device to adjust the refractive index of the first area to a third value corresponding to the first angle and adjust the refractive index of the second area to a fourth value corresponding to the first angle based on identifying that the first angle corresponding to the gaze is greater than a first threshold and not greater than a second threshold that is greater than the first threshold.

According to an embodiment, the instructions, when executed by the at least one processor, may cause the wearable electronic device to adjust the refractive index of the first area to a fifth value corresponding to the first angle and adjust the refractive index of the second area to an initial value based on identifying that the first angle corresponding to the gaze is greater than the second threshold.

According to an embodiment, the lens assembly may further include a second lens configured to adjust the refractive index by receiving an electrical signal.

According to an embodiment, the instructions, when executed by the at least one processor, may cause the wearable electronic device to identify the gaze of a user wearing the wearable electronic device through the camera. According to an embodiment, the instructions, when executed by the at least one processor, may cause the wearable electronic device to adjust each of the refractive index of the first lens and the refractive index of the second lens based on the area where the gaze of the user is directed.

According to an embodiment, the instructions, when executed by the at least one processor, may cause the wearable electronic device to adjust each of the refractive index of the first lens and the refractive index of the second lens to an initial value based on identifying that the gaze of the user is directed toward the second area.

According to an embodiment, the instructions, when executed by the at least one processor, may cause the wearable electronic device to adjust the refractive index of the first lens to the first value and adjust a refractive index of the second lens to an initial value based on identifying that the gaze of the user is directed toward a third area between the first area and the second area.

According to an embodiment, the instructions, when executed by the at least one processor, may cause the wearable electronic device to adjust the refractive index of the first lens to the initial value and adjust the refractive index of the second lens to the second value based on identifying that the gaze of the user is directed toward the second area.

According to an embodiment, the wearable electronic device may include a video see-through (VST) device.

In a method of operating a wearable electronic device 101, 200, 300, or 1201 according to an embodiment, the wearable electronic device may include a display 160, D, or 1260, and a lens assembly LA or 1250 configured to focus or guide light beams representing visual information output from the display, the lens assembly including a first lens 1255 configured to adjust the refractive index by receiving an electrical signal. According to an embodiment, the method of operating the wearable electronic device may include an operation of controlling the display to output the light beams representing the visual information through the lens assembly. According to an embodiment, the method of operating the wearable electronic device may include an operation of adjusting a refractive index of a first area of the first lens corresponding to a first distance from an edge of the first lens to reduce blur of a first object displayed based on the first light beams passing through the first area of the first lens corresponding to the first distance from the edge of the first lens. According to an embodiment, the method of operating the wearable electronic device may include an operation of adjusting the refractive index of the second area of the first lens to a second value corresponding to a second distance, which is longer than the first distance, from the edge of the first lens.

According to an embodiment, the operation of adjusting the refractive index of the first area of the first lens to the first value may include an operation of identifying a gaze of a user wearing the wearable electronic device through a camera 1210 contained in the wearable electronic device. According to an embodiment, the operation of adjusting the refractive index of the first area of the first lens to the first value may include an operation of applying a predetermined first current to the first area of the first lens to adjust the refractive index of the first area of the first lens to the first value based on identifying that the first angle corresponding to the gaze is greater than a first threshold.

According to an embodiment, the method of operating the wearable electronic device may further include an operation of adjusting the refractive index of the first area of the first lens to an initial value based on identifying that the first angle corresponding to the gaze is not greater than a first threshold.

According to an embodiment, the operation of adjusting the refractive index of the first area of the first lens to the initial value may include an operation of applying a predetermined current to at least a portion of the first area to adjust the refractive index of the first area to the initial value.

According to an embodiment, the method of operating the wearable electronic device may further include an operation of applying no current to the first lens based on identifying that the first angle corresponding to the gaze is not greater than a first threshold.

According to an embodiment, the method of operating the wearable electronic device may further include an operation of identifying the gaze of the user wearing the wearable electronic device through the camera. According to an embodiment, the method of operating the wearable electronic device may further include an operation of adjusting the refractive index of the first area to a third value corresponding to the first angle and adjusting the refractive index of the second area to a fourth value corresponding to the first angle based on identifying that the first angle corresponding to the gaze is greater than a first threshold and not greater than a second threshold that is greater than the first threshold.

According to an embodiment, the method of operating the wearable electronic device may further include an operation of adjusting the refractive index of the first area to a fifth value corresponding to the first angle and adjusting the refractive index of the second area to an initial value based on identifying that the first angle corresponding to the gaze is greater than the second threshold.

Although the disclosure has been described with reference to an embodiment as an example, it is to be understood that the embodiment is intended to be exemplary and is not limiting the disclosure. It will be apparent to those skilled in the art that various changes can be made in form and detail without departing from the overall scope of the disclosure, including the appended claims and equivalents to the same.

What is claimed is:

1. A wearable electronic device comprising:
a camera;
a display; and
a lens assembly configured to focus or guide light beams representing visual information output from the display,
wherein the lens assembly comprises:
a first lens configured to adjust a refractive index by receiving an electrical signal,
memory storing one or more computer programs; and
one or more processors communicatively coupled to the camera, the display, the first lens, and the memory,
wherein the one or more computer programs include computer-executable instructions that, when executed by the one or more processors, cause the wearable electronic device to:
control the display to output the light beams representing the visual information through the lens assembly,
adjust a refractive index of a first area of the first lens corresponding to a first distance from an edge of the first lens to a first value to reduce blur of a first object displayed based on first light beams passing through the first area of the first lens corresponding to the first distance from the edge of the first lens, and
adjust a refractive index of a second area of the first lens corresponding to a second distance, which is longer than the first distance, from the edge of the first lens to a second value.

2. The wearable electronic device of claim 1, wherein the one or more computer programs include computer-executable instructions that, when executed by the one or more processors, cause the wearable electronic device to:
identify a gaze of a user wearing the wearable electronic device through the camera, and
apply a predetermined first current to the first area of the first lens to adjust the refractive index of the first area of the first lens to the first value based on identifying that a first angle corresponding to the gaze is greater than a first threshold.

3. The wearable electronic device of claim 2, wherein the one or more computer programs include computer-executable instructions that, when executed by the one or more processors, cause the wearable electronic device to:
adjust the refractive index of the first area of the first lens to an initial value based on identifying that the first angle corresponding to the gaze is not greater than a first threshold.

4. The wearable electronic device of claim 3, wherein the one or more computer programs include computer-executable instructions that, when executed by the one or more processors, cause the wearable electronic device to:
apply a predetermined current to at least a portion of the first area to adjust the refractive index of the first area to the initial value.

5. The wearable electronic device of claim 2, wherein the one or more computer programs include computer-executable instructions that, when executed by the one or more processors, cause the wearable electronic device to:
apply no current to the first lens based on identifying that the first angle corresponding to the gaze is not greater than a first threshold.

6. The wearable electronic device of claim 1, wherein the one or more computer programs include computer-executable instructions that, when executed by the one or more processors, cause the wearable electronic device to:
identify a gaze of a user wearing the wearable electronic device through the camera,
adjust the refractive index of the first area to a third value corresponding to a first angle of the gaze, and
adjust the refractive index of the second area to a fourth value corresponding to the first angle, based on identifying that the first angle corresponding to the gaze is greater than a first threshold and not greater than a second threshold that is greater than the first threshold.

7. The wearable electronic device of claim 6, wherein the one or more computer programs include computer-executable instructions that, when executed by the one or more processors, cause the wearable electronic device to:
adjust the refractive index of the first area to a fifth value corresponding to the first angle, and
adjust the refractive index of the second area to an initial value, based on identifying that the first angle corresponding to the gaze is greater than the second threshold.

8. The wearable electronic device of claim 1, wherein the lens assembly further comprises a second lens configured to adjust a refractive index by receiving an electrical signal.

9. The wearable electronic device of claim 8, wherein the one or more computer programs include computer-executable instructions that, when executed by the one or more processors, cause the wearable electronic device to:
identify a gaze of a user wearing the wearable electronic device through the camera, and
adjust each of the refractive index of the first lens and a refractive index of the second lens based on an area where the gaze of the user is directed.

10. The wearable electronic device of claim 9, wherein the one or more computer programs include computer-executable instructions that, when executed by the one or more processors, cause the wearable electronic device to:
adjust each of the refractive index of the first lens and a refractive index of the second lens to an initial value based on identifying that the gaze of the user is directed toward the second area.

11. The wearable electronic device of claim 9, wherein the one or more computer programs include computer-executable instructions that, when executed by the one or more processors, cause the wearable electronic device to:
adjust the refractive index of the first lens to the first value and adjust a refractive index of the second lens to an initial value based on identifying that the gaze of the user is directed toward a third area between the first area and the second area.

12. The wearable electronic device of claim 9, wherein the one or more computer programs include computer-executable instructions that, when executed by the one or more processors, cause the wearable electronic device to:
adjust the refractive index of the first lens to an initial value and adjust a refractive index of the second lens to the second value based on identifying that the gaze of the user is directed toward the second area.

13. The wearable electronic device of claim 1, further comprising a video see-through (VST) device.

14. A method performed by a wearable electronic device,
wherein the wearable electronic device comprises:
a display, and
a lens assembly configured to focus or guide light beams representing visual information output from the display,
wherein the lens assembly comprises a first lens configured to adjust a refractive index by receiving an electrical signal, and
wherein the method comprises:
controlling, by the wearable electronic device, the display to output the light beams representing the visual information through the lens assembly,
adjusting, by the wearable electronic device, a refractive index of a first area of the first lens corresponding to a first distance from an edge of the first lens to a first value to reduce blur of a first object displayed based on first light beams passing through the first area of the first lens corresponding to the first distance from the edge of the first lens, and
adjusting, by the wearable electronic device, a refractive index of a second area of the first lens corresponding to a second distance, which is longer than the first distance, from the edge of the first lens to a second value.

15. The method of claim 14, wherein the adjusting of the refractive index of the first area of the first lens to the first value comprises:
identifying a gaze of a user wearing the wearable electronic device through a camera contained in the wearable electronic device; and
applying a predetermined first current to the first area of the first lens to adjust the refractive index of the first area of the first lens to the first value based on identifying that a first angle corresponding to the gaze is greater than a first threshold.

16. The method of claim 15, further comprising adjusting the refractive index of the first area of the first lens to an initial value based on identifying that the first angle corresponding to the gaze is not greater than a first threshold.

17. The method of claim 16, wherein the adjusting of the refractive index of the first area of the first lens to the initial value comprises applying a predetermined current to at least a portion of the first area to adjust the refractive index of the first area to the initial value.

18. The method of claim 15, further comprising applying no current to the first lens based on identifying that a first angle corresponding to the gaze is not greater than a first threshold.

19. The method of claim 14, further comprising:
identifying a gaze of a user wearing the wearable electronic device through a camera of the wearable electronic device;
based on identifying that the first angle corresponding to the gaze is greater than a first threshold and not greater than a second threshold that is greater than the first threshold, adjusting the refractive index of the first area to a third value corresponding to a first angle and the refractive index of the second area to a fourth value corresponding to the first angle.

20. One or more non-transitory computer-readable storage media storing one or more computer programs including computer-executable instructions that, when executed by one or more processors of a wearable electronic device, cause the wearable electronic device to perform operations, the operations comprising:
controlling, by the wearable electronic device, a display of the wearable device to output light beams representing visual information through a lens assembly of the wearable device;
adjusting, by the wearable electronic device, a refractive index of a first area of a first lens of the lens assembly corresponding to a first distance from an edge of the first lens to reduce blur of a first object displayed based on first light beams passing through the first area of the first lens corresponding to the first distance from the edge of the first lens; and
adjusting, by the wearable electronic device, a refractive index of a second area of the first lens corresponding to a second distance, which is longer than the first distance, from the edge of the first lens to a second value.
